(19) United States
(12) Patent Application Publication
(10) Pub. No.: US 2023/0246198 A1
(43) Pub. Date: Aug. 3, 2023

(54) POSITIVE ELECTRODE FOR SECONDARY BATTERY, SECONDARY BATTERY, AND ELECTRONIC DEVICE AND SYSTEM

(71) Applicant: SEMICONDUCTOR ENERGY LABORATORY CO., LTD., ATSUGI-SHI, KANAGAWA-KEN (JP)

(72) Inventors: Kaori OGITA, Isehara, Kanagawa (JP); Hiroshi KADOMA, Sagamihara, Kanagawa (JP); Tomoya HIROSE, Atsugi, Kanagawa (JP); Yumiko YONEDA, Isehara, Kanagawa (JP); Yuji IWAKI, Isehara, Kanagawa (JP); Tatsuyoshi TAKAHASHI, Atsugi, Kanagawa (JP); Shunpei YAMAZAKI, Setagaya, Tokyo (JP); Mayumi MIKAMI, Atsugi, Kanagawa (JP); Kazuki TANEMURA, Isehara, Kanagawa (JP)

(21) Appl. No.: 17/766,336

(22) PCT Filed: Sep. 29, 2020
(86) PCT No.: PCT/IB2020/059076

§ 371 Date: Apr. 4, 2022

(30) Foreign Application Priority Data
Oct. 11, 2019 (JP) 2019-187370
Nov. 1, 2019 (JP) 2019-199752
Jul. 28, 2020 (JP) 2020-127004

(51) Int. Cl. H01M 4/62; H01M 4/525; H01M 4/131; H01M 10/0525

(52) U.S. Cl. CPC H01M 4/628; H01M 4/525; H01M 4/131; H01M 10/0525; H01M 2004/028

(57) ABSTRACT

A positive electrode for a secondary battery having excellent cycle performance is provided. The positive electrode for a secondary battery includes a positive electrode current collector layer, a base film, a positive electrode active material layer, and a cap layer; the base film contains titanium nitride; the positive electrode active material layer contains lithium cobalt oxide; and the cap layer contains titanium oxide. The use of titanium nitride for the base film can inhibit oxidation of the positive electrode current collector and diffusion of metal atoms while ensuring an adequate conductivity. The use of titanium oxide for the cap layer can inhibit a side reaction between the positive electrode active material layer and an electrolyte and collapse of a crystal structure of the electrode active material, improving the cycle performance.

### TECHNICAL FIELD

One embodiment of the present invention relates to an object, a method, or a manufacturing method. Alternatively, the present invention relates to a process, a machine, manufacture, or a composition (composition of matter). One embodiment of the present invention relates to a semiconductor device, a display device, a light-emitting device, a power storage device, a lighting device, an electronic device, or a manufacturing method thereof.

Note that electronic devices in this specification generally mean devices including power storage devices, and electro-optical devices including power storage devices, information terminal devices including power storage devices, and the like are all electronic devices.

### BACKGROUND ART

In recent years, a variety of power storage devices such as lithium-ion secondary batteries, lithium-ion capacitors, air batteries, and all-solid-state batteries have been actively developed. In particular, demand for lithium-ion secondary batteries with high output and high capacity has rapidly grown with the development of the semiconductor industry, and the lithium-ion secondary batteries are essential as rechargeable energy supply sources for today's information society.

As the demand expands, the lithium-ion secondary batteries are required to have higher performance. Thus, the positive electrode active material has been improved to enhance the capacity and cycle performance of lithium-ion secondary batteries (e.g., Patent Document 1).

Moreover, among the lithium-ion secondary batteries, an all-solid-state battery having higher safety has been developed. A thin-film secondary battery in which a positive electrode, an electrolyte, and a negative electrode are formed by PVD (physical vapor deposition), CVD (chemical vapor deposition), or the like is one kind of all-solid-state battery (e.g., Patent Document 2).

### REFERENCE

### Patent Document

[Patent Document 1] Japanese Published Patent Application No. 2018-206747
[Patent Document 2] Specification of United States Patent Application Publication No. 2010/0190051

### Non-Patent Document

[Non-Patent Document 1] EELS analysis of cation valence states and oxygen vacancies in magnetic oxides, Z. L. Wang, J. S. Yin, Y. D. Jiang, Micron 31 (2000) 571-580

### SUMMARY OF THE INVENTION

### Problems to be Solved by the Invention

There is room for improvements in a variety of aspects of thin-film secondary batteries, such as charge and discharge characteristics, cycle performance, reliability, safety, and costs. For example, regarding cycle performance, a crystal structure of a positive electrode active material may be broken as charge and discharge are repeated, which might lead to a reduction in charge and discharge capacity. Moreover, a side reaction may occur, for example, at the interface between a positive electrode active material and an electrolyte or the interface between a positive electrode active material and a positive electrode current collector, which might also lead to a reduction in charge and discharge capacity.

In view of the above, an object of one embodiment of the present invention is to provide a positive electrode for a secondary battery in which a side reaction does not easily occur, for example, at the interface between a positive electrode active material and an electrolyte or the interface between a positive electrode active material and a positive electrode current collector even when charge and discharge are repeated. Another object is to provide a positive electrode for a secondary battery, which has a crystal structure that is not easily broken even when charge and discharge are repeated. Another object is to provide a positive electrode for a secondary battery, which has excellent charge and discharge cycle performance. Another object is to provide a positive electrode for a secondary battery, which has high charge and discharge capacity. Another object is to provide a positive electrode for a secondary battery, in which a decrease in capacity in charge and discharge cycles is inhibited. Another object is to provide a secondary battery with excellent charge and discharge cycle performance. Another object is to provide a secondary battery with high charge and discharge capacity. Another object is to provide a highly safe or reliable secondary battery.

Another object of one embodiment of the present invention is to provide a novel material, novel active material particles, a novel power storage device, or a manufacturing method thereof.

Note that the description of these objects does not preclude the existence of other objects. One embodiment of the present invention does not have to achieve all these objects. Other objects can be derived from the description of the specification, the drawings, and the claims.

### Means for Solving the Problems

In one embodiment of the present invention, a cap layer is provided over a positive electrode active material layer in order to make a crystal structure less likely to be broken, inhibit a side reaction, and improve cycle performance.

One embodiment of the present invention is a positive electrode for a secondary battery, which includes a base film, a positive electrode active material layer, and a cap layer. At least one of the base film and the cap layer contains titanium oxynitride. The positive electrode active material layer contains lithium cobalt oxide. The cap layer contains a titanium compound containing oxygen.

In the above, a crystal structure included in the base film and a crystal structure included in the positive electrode active material layer each preferably have a plane where only anions are arranged.

In the above, the base film and the positive electrode active material layer each preferably have a crystal structure where cations and anions are alternately arranged.

One embodiment of the present invention is a secondary battery including the above positive electrode for a secondary battery, a solid electrolyte, and a negative electrode.

One embodiment of the present invention is an electronic device including the above secondary battery.

One embodiment of the present invention is an electronic device including the above secondary battery and a lithium-ion secondary battery which includes a positive electrode, a negative electrode, an electrolytic solution, and a separator.

### Effect of the Invention

One embodiment of the present invention can provide a positive electrode for a secondary battery in which a side reaction does not easily occur, for example, at the interface between a positive electrode active material and an electrolyte or the interface between a positive electrode active material and a positive electrode current collector even when charge and discharge are repeated. A positive electrode for a secondary battery, which has a crystal structure that is not easily broken even when charge and discharge are repeated, can be provided. A positive electrode for a secondary battery, which has excellent charge and discharge cycle performance, can be provided. A positive electrode for a secondary battery, which has high charge and discharge capacity, can be provided. A positive electrode for a secondary battery, in which a decrease in capacity in charge and discharge cycles is inhibited, can be provided. A secondary battery with excellent charge and discharge cycle performance can be provided. A secondary battery with high charge and discharge capacity can be provided. A highly safe or reliable secondary battery can be provided.

One embodiment of the present invention can provide a novel material, novel active material particles, a novel power storage device, or a manufacturing method thereof.

Note that the description of these effects does not preclude the existence of other effects. One embodiment of the present invention does not have to have all of these effects. Other effects will be apparent from and can be derived from the description of the specification, the drawings, the claims, and the like.

### BRIEF DESCRIPTION OF THE DRAWINGS

FIG. 1A to FIG. 1C are perspective views of a positive electrode of one embodiment of the present invention.

FIG. 2A and FIG. 2B are diagrams each showing a crystal structure of the positive electrode of one embodiment of the present invention.

FIG. 3A to FIG. 3C are diagrams each showing a stacked-layer structure of a secondary battery of one embodiment of the present invention.

FIG. 4A is a top view illustrating one embodiment of the present invention, and FIG. 4B to FIG. 4D are cross-sectional views illustrating one embodiment of the present invention.

FIG. 5A and FIG. 5C are top views illustrating one embodiment of the present invention, and FIG. 5B and FIG. 5D are cross-sectional views illustrating one embodiment of the present invention.

FIG. 6A is a top view illustrating one embodiment of the present invention, and FIG. 6B is a cross-sectional view illustrating one embodiment of the present invention.

FIG. 7A is a top view illustrating one embodiment of the present invention, and FIG. 7B is a cross-sectional view illustrating one embodiment of the present invention.

FIG. 8 is a diagram showing a manufacturing flow of a secondary battery of one embodiment of the present invention.

FIG. 9A and FIG. 9B are top views each illustrating one embodiment of the present invention.

FIG. 10 is a cross-sectional view illustrating one embodiment of the present invention.

FIG. 11 is a diagram showing a manufacturing flow of a secondary battery of one embodiment of the present invention.

FIG. 12 is a schematic top view of a manufacturing apparatus for a secondary battery.

FIG. 13 is a cross-sectional view of part of a manufacturing apparatus for a secondary battery.

FIG. 14A is a perspective view illustrating an example of a battery cell. FIG. 14B is a perspective view of a circuit. FIG. 14C is a perspective view of the battery cell and the circuit which overlap with each other.

FIG. 15A is a perspective view illustrating an example of a battery cell. FIG. 15B is a perspective view of a circuit. FIG. 15C and FIG. 15D are perspective views of the battery cell and the circuit which overlap with each other.

FIG. 16A is a perspective view of a battery cell. FIG. 16B is a diagram illustrating an example of an electronic device.

FIG. 17A to FIG. 17C are diagrams illustrating examples of electronic devices.

FIG. 18A to FIG. 18C are diagrams illustrating examples of electronic devices.

FIG. 19A to FIG. 19D are diagrams illustrating examples of electronic devices.

FIG. 20A is a diagram illustrating part of a system of one embodiment of the present invention. FIG. 20B is a diagram illustrating examples of electronic devices of one embodiment of the present invention.

FIG. 21A is a schematic view of an electronic device of one embodiment of the present invention. FIG. 21B is a diagram illustrating part of a system, and FIG. 21C is an example of perspective view of a portable data terminal used in the system.

FIG. 22A and FIG. 22B are graphs of the charge and discharge characteristics of secondary batteries in Example 1.

FIG. 23A and FIG. 23B are graphs of the cycle performance of secondary batteries in Example 1.

FIG. 24 is a cross-sectional TEM image of a positive electrode in Example 2.

FIG. 25A is a cross-sectional TEM image of a positive electrode active material layer in Example 2. FIG. 25B is a nanobeam electron diffraction pattern of the positive electrode active material layer in Example 2.

FIG. 26A and FIG. 26B are nanobeam electron diffraction patterns of a positive electrode active material layer in Example 2.

FIG. 27 is a cross-sectional TEM image of a positive electrode in Example 2.

FIG. 28A and FIG. 28B are cross-sectional TEM images of a positive electrode in Example 2.

FIG. 29 is EELS spectra of a positive electrode active material layer in Example 2.

FIG. 30 is a cross-sectional TEM image of a positive electrode in Example 2.

FIG. 31A and FIG. 31B are cross-sectional TEM images of a positive electrode in Example 2.

FIG. 32 is EELS spectra of a positive electrode active material layer in Example 2.

FIG. 33A is a cross-sectional TEM image of a positive electrode active material layer in Example 2. FIG. 33B is a nanobeam electron diffraction pattern of the positive electrode active material layer in Example 2.

FIG. 34A and FIG. 34B are nanobeam electron diffraction patterns of a positive electrode active material layer in Example 2.

FIG. 35A is a cross-sectional TEM image of a positive electrode active material layer in Example 2. FIG. 35B is a nanobeam electron diffraction pattern of the positive electrode active material layer in Example 2.

FIG. 36A and FIG. 36B are nanobeam electron diffraction patterns of a positive electrode active material layer in Example 2.

FIG. 37 is a graph showing the charge and discharge cycle performance of secondary batteries in Example 2.

FIG. 38A and FIG. 38B are diagrams showing the impedance measurement of secondary batteries in Example 2.

FIG. 39 is the impedance measurement result of a secondary battery in Example 2.

FIG. 40 is the impedance measurement result of a secondary battery in Example 2.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

The Miller index is used for the expression of crystal planes and orientations in this specification and the like. An individual plane representing a crystal plane is denoted by “( )”. An orientation is denoted by “[ ]”. A reciprocal lattice point is represented using a similar index without parentheses or brackets. In the crystallography, a bar is placed over a number in the expression of crystal planes, orientations, and space groups; however, in this specification and the like, because of application format limitations, crystal planes, orientations, and space groups are sometimes expressed by placing a minus sign (−) before a number instead of placing a bar over the number.

In this specification and the like, a layered rock-salt crystal structure of a composite oxide containing lithium and a transition metal refers to a crystal structure in which a rock-salt ion arrangement where cations and anions are alternately arranged is included and the transition metal and lithium are regularly arranged to form a two-dimensional plane, so that lithium can be two-dimensionally diffused. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which cations and anions are alternately arranged. Note that a cation or anion vacancy may exist.

Anions of a layered rock-salt crystal and anions of a rock-salt crystal have a cubic closest packed structure (face-centered cubic lattice structure). When the layered rock-salt crystal and the rock-salt crystal are in contact with each other, there is a crystal plane at which orientations of cubic closest packed structures composed of anions are aligned. Note that a space group of the layered rock-salt crystal is R-3m, which is different from a space group Fm-3m of a rock-salt crystal; thus, the Miller index of the crystal plane satisfying the above conditions in the layered rock-salt crystal is different from that in the rock-salt crystal. In this specification, a state where the orientations of the cubic closest packed structures composed of anions in the layered rock-salt crystal and the rock-salt crystal are aligned is sometimes referred to as a state where crystal orientations are substantially aligned.

Whether the crystal orientations in two regions are substantially aligned with each other can be judged from a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, and the like. X-ray diffraction (XRD), electron diffraction, neutron diffraction, and the like can also be used for judging. When the crystal orientations are substantially aligned with each other, a state where an angle between the orientations of lines in each of which cations and anions are alternately arranged is less than or equal to 5°, or less than or equal to 2.5° is observed from a TEM image and the like. Note that in a TEM image and the like, a light element typified by oxygen or fluorine cannot be clearly observed in some cases; in such a case, alignment of orientations can be judged by arrangement of metal elements.

In this specification and the like, theoretical capacity of a positive electrode active material refers to the amount of electricity at the time when lithium that can be inserted and extracted and is contained in the positive electrode active material is all extracted. For example, the theoretical capacity of LiCoO₂ is 274 mAh/g, the theoretical capacity of LiNiO₂ is 274 mAh/g, and the theoretical capacity of LiMn₂O₄ is 148 mAh/g.

In this specification and the like, charge depth at the time when lithium that can be inserted and extracted is all inserted is 0, and charge depth at the time when lithium that can be inserted and extracted and is contained in a positive electrode active material is all extracted is 1.

In this specification and the like, the expression “planes are parallel to each other” refers to not only the case where the planes are exactly parallel numerically but also the case where an angle formed between the planes is 5° or less, or 2.5° or less.

### Embodiment 1

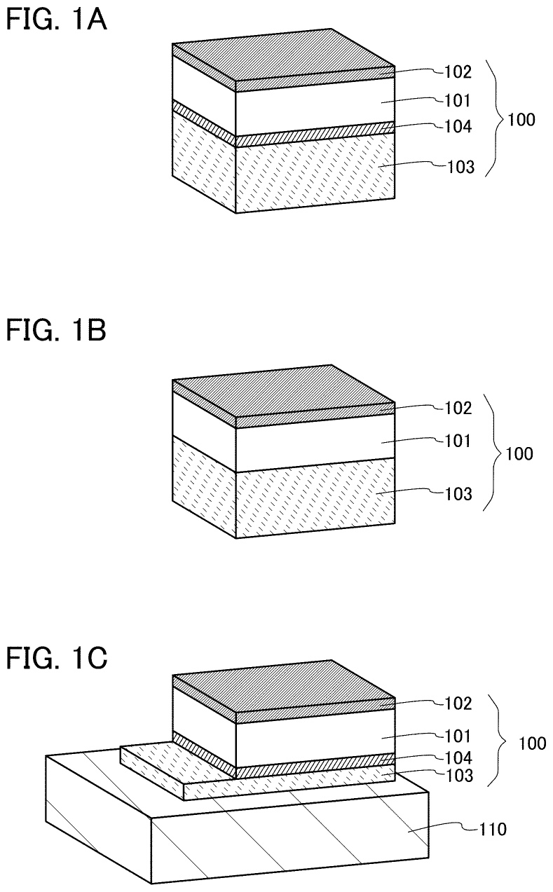

A positive electrode for a secondary battery of one embodiment of the present invention will be described with reference to FIG. 1.

FIG. 1A is a perspective view of an example of a positive electrode 100 of one embodiment of the present invention. The positive electrode 100 includes a positive electrode current collector 103, a base film 104, a positive electrode active material layer 101, and a cap layer 102.

The base film 104 is provided between the positive electrode current collector 103 and the positive electrode active material layer 101. The base film 104 has a function of increasing conductivity between the positive electrode current collector 103 and the positive electrode active material layer 101. Alternatively, the base film 104 has a function of inhibiting a side reaction such as oxidation of the positive electrode current collector 103 due to oxygen contained in the positive electrode active material layer 101 or the like or diffusion of a metal atom included in the positive electrode current collector 103 into the positive electrode active material layer 101. Alternatively, the base film 104 has a function of stabilizing a crystal structure included in the positive electrode active material layer 101.

For the base film 104, a material having conductivity is preferably used. Moreover, a material that is likely to inhibit oxidation is preferably used. For example, it is possible to use a titanium compound such as titanium oxide, titanium nitride, titanium oxide in which nitrogen is substituted for part of oxygen, titanium nitride in which oxygen is substituted for part of nitrogen, or titanium oxynitride (TiOₓN_{y}, where 0<x<2 and 0<y<1). Titanium nitride is particularly preferable because it has high conductivity and has a high capability of inhibiting oxidation.

The cap layer 102 is provided over the positive electrode active material layer 101. The cap layer 102 has a function of inhibiting a side reaction between the positive electrode active material layer 101 and an electrolyte. Alternatively, the cap layer 102 has a function of stabilizing a crystal structure included in the positive electrode active material layer 101.

For the cap layer 102, a titanium compound is preferably used. For example, it is preferable to use titanium oxide, titanium nitride, titanium oxide in which nitrogen is substituted for part of oxygen, titanium nitride in which oxygen is substituted for part of nitrogen, or titanium oxynitride (TiOₓN_{y}, where 0<x<2 and 0<y<1). Titanium and oxygen are materials that can be contained in a solid electrolyte. Therefore, titanium oxide is particularly preferable for the cap layer 102.

Note that in this specification and the like, an electrolyte refers to not only a solid electrolyte but also an electrolytic solution in which lithium salt is dissolved in a liquid solvent and an electrolytic solution in which lithium salt is dissolved in a gelled compound.

The positive electrode active material layer 101 contains lithium, a transition metal M, and oxygen. In other words, the positive electrode active material layer 101 includes a composite oxide containing lithium and the transition metal M.

As the transition metal M contained in the positive electrode active material layer 101, a metal that can form, together with lithium, a layered rock-salt composite oxide belonging to the space group R-3m is preferably used. As the transition metal M, one or more of manganese, cobalt, and nickel can be used, for example. That is, as the transition metal contained in the positive electrode active material layer 101, only cobalt may be used; only nickel may be used; two metals of cobalt and manganese or cobalt and nickel may be used; or three metals of cobalt, manganese, and nickel may be used. In other words, the positive electrode active material layer 101 can include a composite oxide containing lithium and the transition metal M, such as lithium cobalt oxide, lithium nickel oxide, lithium cobalt oxide in which manganese is substituted for part of cobalt, lithium cobalt oxide in which nickel is substituted for part of cobalt, or lithium nickel-manganese-cobalt oxide.

In addition to the above, the positive electrode active material layer 101 may contain an element other than the transition metal M, such as magnesium, fluorine, or aluminum. Such elements further stabilize a crystal structure included in the positive electrode active material layer 101 in some cases. In other words, the positive electrode active material layer 101 can contain lithium cobalt oxide to which magnesium and fluorine are added, lithium nickel-cobalt oxide to which magnesium and fluorine are added, lithium cobalt-aluminum oxide to which magnesium and fluorine are added, lithium nickel-cobalt-aluminum oxide, lithium nickel-cobalt-aluminum oxide to which magnesium and fluorine are added, or the like.

When the positive electrode active material layer 101 contains lithium, cobalt, nickel, aluminum, magnesium, oxygen, and fluorine, given that the proportion of cobalt atoms included in the positive electrode active material layer 101 is 100, the proportion of nickel atoms is preferably greater than or equal to 0.05 and less than or equal to 2, further preferably greater than or equal to 0.1 and less than or equal to 1.5, and still further preferably greater than or equal to 0.1 and less than or equal to 0.9, for example. Given that the proportion of cobalt atoms included in the positive electrode active material layer 101 is 100, the proportion of aluminum atoms is preferably greater than or equal to 0.05 and less than or equal to 2, further preferably greater than or equal to 0.1 and less than or equal to 1.5, and still further preferably greater than or equal to 0.1 and less than or equal to 0.9, for example. Given that the proportion of cobalt atoms included in the positive electrode active material layer 101 is 100, the proportion of magnesium atoms is preferably greater than or equal to 0.1 and less than or equal to 6, further preferably greater than or equal to 0.3 and less than or equal to 3, for example. Given that the proportion of magnesium atoms included in the positive electrode active material layer 101 is 1, the proportion of fluorine atoms is preferably greater than or equal to 2 and less than or equal to 3.9, for example.

When nickel, aluminum, and magnesium are contained at the above concentrations, a stable crystal structure can be maintained even if charge and discharge are repeated at high voltage. Thus, the positive electrode active material layer 101 can have high capacity and excellent charge and discharge cycle performance.

The molar concentrations of cobalt, nickel, aluminum, and magnesium can be measured by inductively coupled plasma mass spectrometry (ICP-MS), for example. The molar concentration of fluorine can be measured by glow discharge mass spectrometry (GD-MS), for example.

### <Ab Initio Calculations>

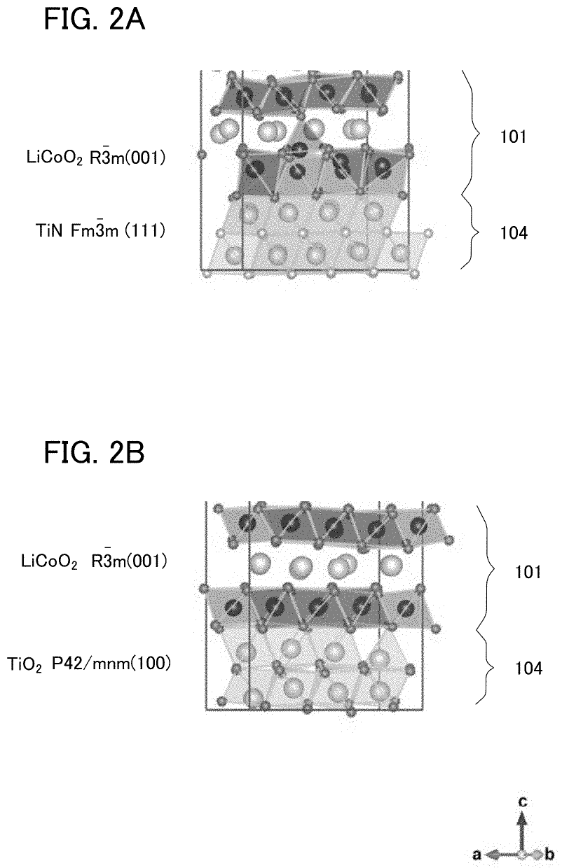

Here, the results of calculating a crystal structure at the interface between the positive electrode active material layer 101 and the base film 104 in the case where lithium cobalt oxide is used for the positive electrode active material layer 101 will be described with reference to FIG. 2.

FIG. 2A shows the case where titanium nitride is used for the base film 104. The calculation is performed given that titanium nitride has a rock-salt crystal structure that belongs to the space group Fm-3m and lithium cobalt oxide has a layered rock-salt crystal structure that belongs to the space group R-3m. The base film 104 and the positive electrode active material layer 101 are stacked such that the (111) plane of titanium nitride and the (001) plane of lithium cobalt oxide are parallel to each other.

FIG. 2B shows the case where titanium oxide is used for the base film 104. The calculation is performed given that titanium oxide has a rutile crystal structure that belongs to the space group P42/mnm and lithium cobalt oxide has a layered rock-salt crystal structure that belongs to the space group R-3m. The base film 104 and the positive electrode active material layer 101 are stacked such that the (100) plane of titanium oxide and the (001) plane of lithium cobalt oxide are parallel to each other.

Both these diagrams selectively show the interface between the positive electrode active material layer 101 and the base film 104. Other calculation conditions are listed in Table 1.

TABLE 1

| Software | VASP | |
|---|---|---|
| Functional | GGA + U (DFT-D2) | |
| Pseudo potential | PAW | |
| Cut-off energy (eV) | 600 | |
| U potential | Co | 4.91 |
| Number of atoms | TiN base film | Li 48, Co 48, O 96, Ti 32, N 32 |
| | TiO₂ base | Li 48, Co 48, O 128, Ti 16 |
| | film | |

| | |
|---|---|
| k-points | 1 × 1 × 1 |
| MD temperature | 600K |
| Time step width | 2 fs |

In the case of FIG. 2A in which titanium nitride is used for the base film 104, the Ti—O distance is 2.03 Å, the Ti—N distance is 1.93 Å, the Co—O distance is 2.25 Å, and the Co—N distance is 2.21 Å. Note that 1 Å=10⁻¹⁰ m.

In the rock-salt crystal structure that belongs to the space group Fm-3m, a plane where only anions are arranged exists parallel to the (111) plane. In titanium nitride, only nitrogen atoms are arranged on a plane parallel to the (111) plane. In the layered rock-salt crystal structure that belongs to the space group R-3m, a plane where only anions are arranged exists parallel to the (001) plane. In lithium cobalt oxide, only oxygen atoms are arranged on a plane parallel to the (001) plane.

When the (111) plane of titanium nitride and the (001) plane of lithium cobalt oxide are parallel to each other, planes where only anions are arranged are parallel to each other in both of these materials, so that the crystal structure is likely to become stable.

The rock-salt crystal structure that belongs to the space group Fm-3m and the layered rock-salt crystal structure that belongs to the space group R-3m can each be regarded as a crystal structure in which cations and anions are alternately arranged. Thus, when lithium cobalt oxide having a layered rock-salt crystal structure is stacked over titanium nitride having a rock-salt crystal structure, orientation of crystals in the base film 104 and orientation of crystals in the positive electrode active material layer 101 are likely to be substantially aligned with each other.

Meanwhile, in the case of FIG. 2B in which titanium oxide is used for the base film 104, the Ti—O distance is 2.15 Å and the Co—O distance is 1.91 Å. In titanium oxide having a rutile crystal structure, oxygen atoms are not arranged on a plane parallel to the (100) plane. Therefore, titanium oxide possibly has a lower capability of stabilizing a layered rock-salt crystal structure than titanium nitride.

As described above, titanium nitride is particularly preferable for the base film 104 when lithium cobalt oxide having a layered rock-salt crystal structure is used for the positive electrode active material layer 101.

FIG. 1B is a perspective view of another example of the positive electrode 100 of one embodiment of the present invention. The positive electrode 100 illustrated in FIG. 1B includes the positive electrode current collector 103, the positive electrode active material layer 101, and the cap layer 102. In this manner, the positive electrode 100 does not necessarily include the base film 104. Even when the base film 104 is not provided, the secondary battery can sometimes have adequately high cycle performance by including the cap layer 102.

Although FIG. 1A and FIG. 1B show the positive electrode in which the positive electrode current collector 103 serves as both a current collector and a substrate, one embodiment of the present invention is not limited thereto. FIG. 1C is a perspective view of another example of the positive electrode 100 of one embodiment of the present invention. As illustrated in FIG. 1C, the positive electrode 100 may be formed by depositing the positive electrode current collector 103, the base film 104, the positive electrode active material layer 101, and the cap layer 102 over a substrate 110.

This embodiment can be implemented in appropriate combination with the other embodiments.

### Embodiment 2

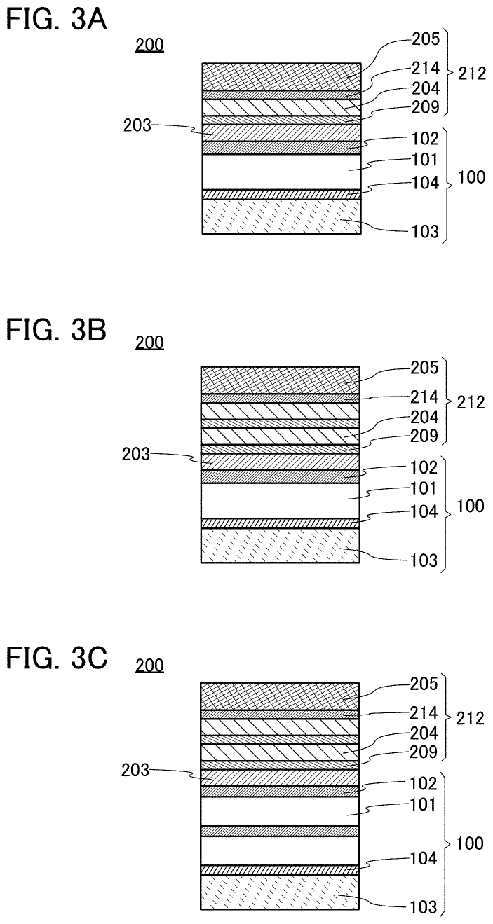

In this embodiment, a secondary battery including the positive electrode for a secondary battery described in Embodiment 1, and a manufacturing method of the secondary battery will be described with reference to FIG. 3 to FIG. 8.

### [Structure of Secondary Battery]

FIG. 3A is a diagram illustrating an example of a stacked-layer structure of a secondary battery 200 including the positive electrode 100 for a secondary battery of one embodiment of the present invention.

The secondary battery 200 is a thin-film battery including the positive electrode 100 described in the foregoing embodiment, in which a solid electrolyte layer 203 is formed over the positive electrode 100 and a negative electrode 212 is formed over the solid electrolyte layer 203. The negative electrode 212 includes a negative electrode current collector 205 and a negative electrode active material layer 204. As illustrated in FIG. 3A, the negative electrode 212 preferably includes a base film 214 and a cap layer 209.

The base film 214 is provided between the negative electrode current collector 205 and the negative electrode active material layer 204. The base film 214 has a function of increasing conductivity between the negative electrode current collector 205 and the negative electrode active material layer 204. Alternatively, the base film 214 has a function of suppressing excessive expansion of the negative electrode active material layer. Alternatively, the base film 214 has a function of inhibiting a side reaction between the negative electrode current collector 205 and the negative electrode active material layer 204.

For the base film 214, it is preferable to use a material having conductivity. It is preferable to use a material capable of suppressing excessive expansion of the negative electrode active material layer. It is preferable to use a material that is likely to inhibit a side reaction. For example, it is preferable to use a titanium compound such as titanium oxide, titanium nitride, titanium oxide in which nitrogen is substituted for part of oxygen, titanium nitride in which oxygen is substituted for part of nitrogen, or titanium oxynitride (TiOₓN_{y}, where 0<x<2 and 0<y<1). Titanium nitride is particularly preferable because it has high conductivity and has a high capability of inhibiting a side reaction.

The cap layer 209 is provided between the negative electrode active material layer 204 and the solid electrolyte layer 203. The cap layer 209 has a function of inhibiting a side reaction between the negative electrode active material layer 204 and the solid electrolyte layer 203.

For the cap layer 209, titanium or a titanium compound is preferably used. As the titanium compound, it is preferable to use titanium oxide, titanium nitride, titanium oxide in which nitrogen is substituted for part of oxygen, titanium nitride in which oxygen is substituted for part of nitrogen, or titanium oxynitride (TiOₓN_{y}, where 0<x<2 and 0<y<1), for example. Titanium is a material that can be contained in a solid electrolyte. Therefore, titanium and a titanium compound are particularly preferable for the cap layer 209.

For the negative electrode active material layer 204, silicon, carbon, titanium oxide, vanadium oxide, indium oxide, zinc oxide, tin oxide, nickel oxide, or the like can be used. A material that is alloyed with lithium, such as tin, gallium, or aluminum can be used. Alternatively, an oxide of such a metal that is alloyed with lithium may be used. A lithium titanium oxide (Li₄Ti₅O₁₂, LiTi₂O₄, or the like) may be used; in particular, a material containing silicon and oxygen (also referred to as a SiOₓ film) is preferable. A lithium metal may also be used for the negative electrode active material layer 204. Alternatively, a mixture of these materials may be used. A mixture of a silicon particle and carbon, for example, is preferable because of having favorable reliability and a relatively high energy density per volume.

The solid electrolyte layer 203 is provided between the positive electrode 100 and the negative electrode 212. Examples of materials for the solid electrolyte layer 203 include Li_{0.35}La_{0.55}TiO₃, La_{(2/3-A)}Li_{3A}TiO₃, Li₃PO₄, LixPO_{(4-B)}N_{B}, LiNb_{(1-A)}Ta_{(A)}WO₆, Li₇La₃Zr₂O₁₂, Li_{(1+A)}Al_{(A)}Ti_{(2-A)}(PO₄)₃, Li_{(1+A)}Al_{(A)}Ge_{(2-A)}(PO₄)₃, and LiNbO₂. Note that A>0 and B>0. As a deposition method, a sputtering method, an evaporation method, or the like can be used.

A compound containing titanium is preferably used for the solid electrolyte layer 203. Since the cap layer 102 included in the positive electrode 100 and the cap layer 209 included in the negative electrode 212 contain titanium, the secondary battery can be easily manufactured when a material containing titanium is also used for the solid electrolyte layer 203.

In addition, SiO_{C} (0<C≤2) can also be used for the solid electrolyte layer 203. SiO_{C} (0<C≤2) may be used for the solid electrolyte layer 203, and SiO_{C} (0<C≤2) may also be used for the negative electrode active material layer 204. In this case, the ratio of oxygen to silicon (O/Si) in SiO_{C} is preferably higher in the solid electrolyte layer 203 than in the negative electrode active material layer 204. With this structure, conductive ions (particularly lithium ions) in the solid electrolyte layer 203 are likely to diffuse, and conductive ions (particularly lithium ions) in the negative electrode active material layer 204 are likely to be extracted or accumulated, whereby a solid-state secondary battery with favorable characteristics can be obtained. When the solid electrolyte layer 203 and the negative electrode active material layer 204 are formed using materials containing the same components as described above, a secondary battery can be manufactured easily.

The solid electrolyte layer 203 may have a stacked-layer structure. In the case of a stacked-layer structure, a material in which nitrogen is added to lithium phosphate (Li₃PO₄) (the material is also referred to as Li₃PO_{(4-Z)}N_{Z}:LiPON) may be stacked as one of the layers. Note that Z>0.

As illustrated in FIG. 3B, the secondary battery 200 may include the negative electrode 212 in which a plurality of negative electrode active material layers 204 and a plurality of cap layers 209 are stacked. When a plurality of negative electrode active material layers 204 and a plurality of cap layers 209 are stacked, excessive expansion of the negative electrode 212 can be suppressed while the capacity is increased. In this case, the cap layer 209 in contact with the solid electrolyte layer 203 and the cap layer 209 sandwiched between the negative electrode active material layers 204 may be formed using the same material or different materials. For example, titanium oxide may be used for the cap layer 209 in contact with the solid electrolyte layer 203, and titanium nitride may be used for the cap layer 209 sandwiched between the negative electrode active material layers 204.

As illustrated in FIG. 3C, the secondary battery 200 may include the positive electrode 100 in which a plurality of positive electrode active material layers 101 and a plurality of cap layers 102 are stacked. When a plurality of positive electrode active material layers 101 and a plurality of cap layers 102 are stacked, collapse of a crystal structure included in the positive electrode active material layers 101 can be suppressed while the capacity is increased. In this case, the cap layer 102 in contact with the solid electrolyte layer 203 and the cap layer 102 sandwiched between the positive electrode active material layers 101 may be formed using the same material or different materials. For example, titanium oxide may be used for the cap layer 102 in contact with the solid electrolyte layer 203, and titanium nitride may be used for the cap layer 102 sandwiched between the positive electrode active material layers 101.

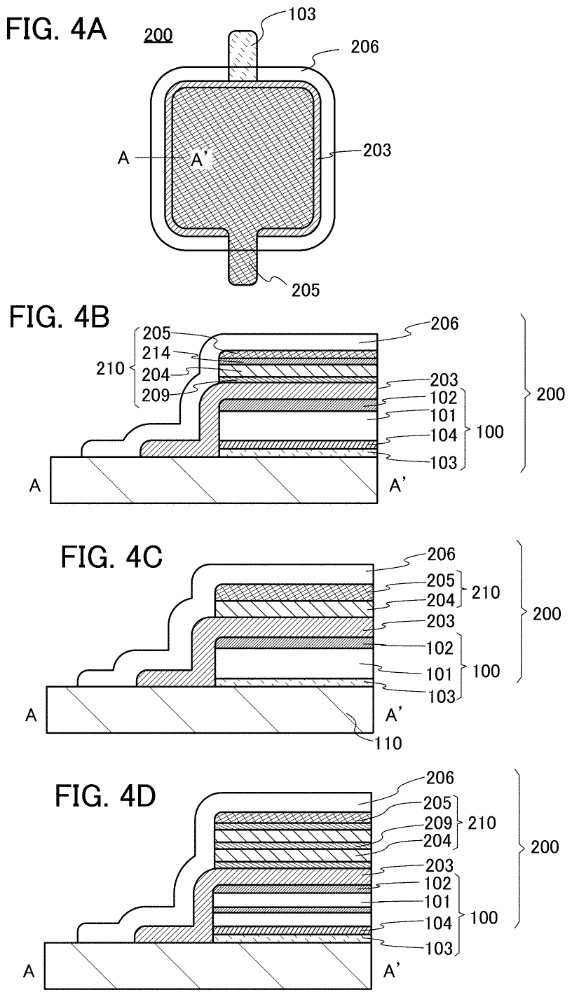

FIG. 4A and FIG. 4B illustrate a more specific example of the secondary battery 200 of one embodiment of the present invention. The secondary battery 200 formed over the substrate 110 is described here.

FIG. 4A is a top view, and FIG. 4B is a cross-sectional view taken along the line A-A′ in FIG. 4A. The secondary battery 200 is a thin-film battery, in which the positive electrode 100 described in the foregoing embodiment is formed over the substrate 110, the solid electrolyte layer 203 is formed over the positive electrode 100, and a negative electrode 210 is formed over the solid electrolyte layer 203 as illustrated in FIG. 4B. The negative electrode 210 includes the negative electrode current collector 205, the base film 214, the negative electrode active material layer 204, and the cap layer 209.

In the secondary battery 200, a protective layer 206 is preferably formed over the positive electrode 100, the solid electrolyte layer 203, and the negative electrode 210.

Films for forming these layers can be formed using metal masks. The positive electrode current collector 103, the base film 104, the positive electrode active material layer 101, the cap layer 102, the solid electrolyte layer 203, the cap layer 209, the negative electrode active material layer 204, the base film 214, and the negative electrode current collector 205 can be selectively formed by a sputtering method. Furthermore, the solid electrolyte layer 203 may be selectively formed using a metal mask by a co-evaporation method.

As illustrated in FIG. 4A, part of the negative electrode current collector 205 is exposed to form a negative electrode terminal portion, and part of the positive electrode current collector 103 is exposed to form a positive electrode terminal portion. A region other than the negative electrode terminal portion and the positive electrode terminal portion is covered with the protective layer 206.

In FIG. 4A and FIG. 4B, the structure where the solid electrolyte layer 203, the negative electrode active material layer 204, and the negative electrode current collector 205 are stacked in this order over the positive electrode 100 including the positive electrode current collector 103, the base film 104, the positive electrode active material layer 101, and the cap layer 102 is described; however, one embodiment of the present invention is not limited thereto.

As illustrated in FIG. 4C, the secondary battery 200 may include the positive electrode 100 that does not include the base film 104 between the positive electrode current collector 103 and the positive electrode active material layer 101. Moreover, the secondary battery 200 may include the negative electrode 210 that does not include the base film 214 and the cap layer 209.

Each of the positive electrode and the negative electrode included in the secondary battery of one embodiment of the present invention may have a stacked-layer structure of active material layers and cap layers. For example, as illustrated in FIG. 4D, the secondary battery 200 may include the negative electrode 210 in which a plurality of negative electrode active material layers 204 and a plurality of cap layers 209 are stacked. Moreover, the secondary battery 200 may include the positive electrode 100 in which a plurality of positive electrode active material layers 101 and a plurality of cap layers 102 are stacked.

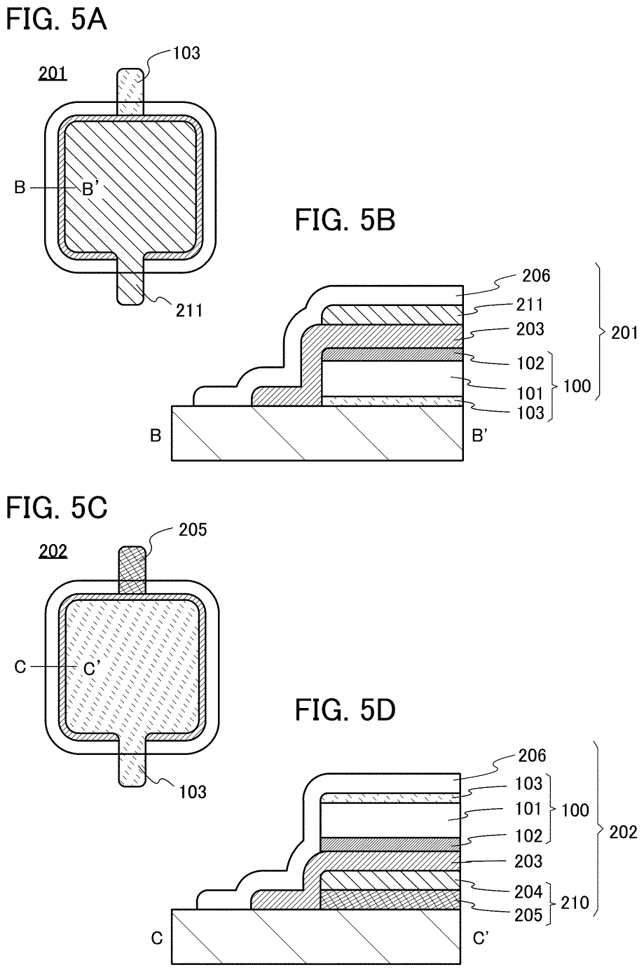

As illustrated in FIG. 5A and FIG. 5B, the secondary battery of one embodiment of the present invention may be a secondary battery 201 including a negative electrode 211 that serves as a negative electrode current collector layer and a negative electrode active material layer. FIG. 5A is a top view of the secondary battery 201, and FIG. 5B is a cross-sectional view taken along the line B-B′ in FIG. 5A. With the negative electrode 211 serving as both a negative electrode current collector layer and a negative electrode active material layer, the secondary battery can have a simplified process and high productivity. In addition, the secondary battery can have high energy density.

As illustrated in FIG. 5C and FIG. 5D, the secondary battery of one embodiment of the present invention may be a secondary battery 202 in which the solid electrolyte layer 203 and the positive electrode 100 are stacked over the negative electrode 210. FIG. 5C is a top view of the secondary battery 202, and FIG. 5D is a cross-sectional view taken along the line C-C′ in FIG. 5C.

Although the secondary battery in which not only the positive electrode but also the solid electrolyte layer and the negative electrode are formed of thin films is described in FIG. 4 and FIG. 5, one embodiment of the present invention is not limited to this. One embodiment of the present invention may be a secondary battery including an electrolytic solution. Alternatively, one embodiment of the present invention may be a secondary battery including an electrolytic solution and a negative electrode serving as both a negative electrode current collector layer and a negative electrode active material layer. Alternatively, one embodiment of the present invention may be a secondary battery including a negative electrode formed by coating a negative electrode current collector with powder of a negative electrode active material.

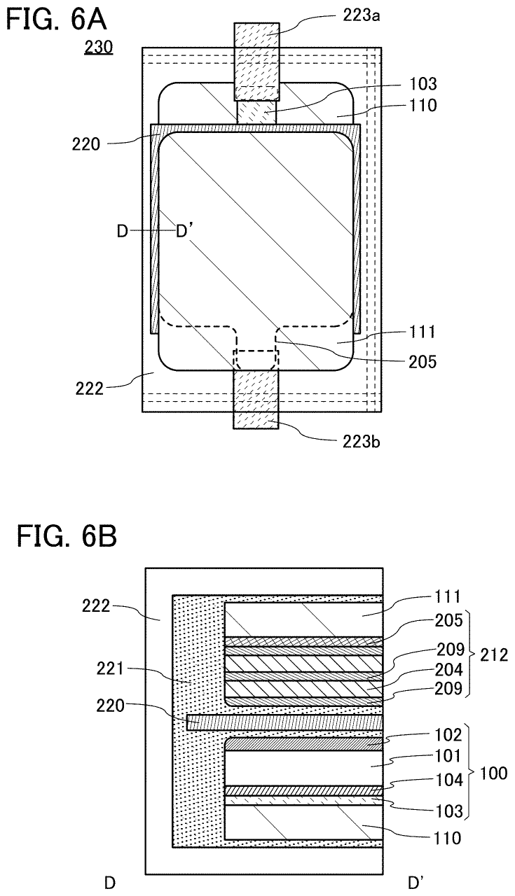

FIG. 6A and FIG. 6B illustrate a secondary battery 230 including an electrolytic solution. FIG. 6A is a top view, and FIG. 6B is a cross-sectional view taken along the line D-D′ in FIG. 6A.

As illustrated in FIG. 6B, the secondary battery 230 includes the positive electrode 100 over the substrate 110, the negative electrode 212 over a substrate 111, a separator 220, an electrolytic solution 221, and an exterior body 222. The negative electrode current collector 205, the negative electrode active material layer 204, and the cap layer 209 included in the negative electrode 212 are formed of thin films.

In addition, as illustrated in FIG. 6A, the secondary battery 230 includes a lead electrode 223a and a lead electrode 223b. The lead electrode 223a is electrically connected to the positive electrode current collector 103. The lead electrode 223b is electrically connected to the negative electrode current collector 205. The lead electrode 223a and the lead electrode 223b are partly led to the outside of the exterior body 222.

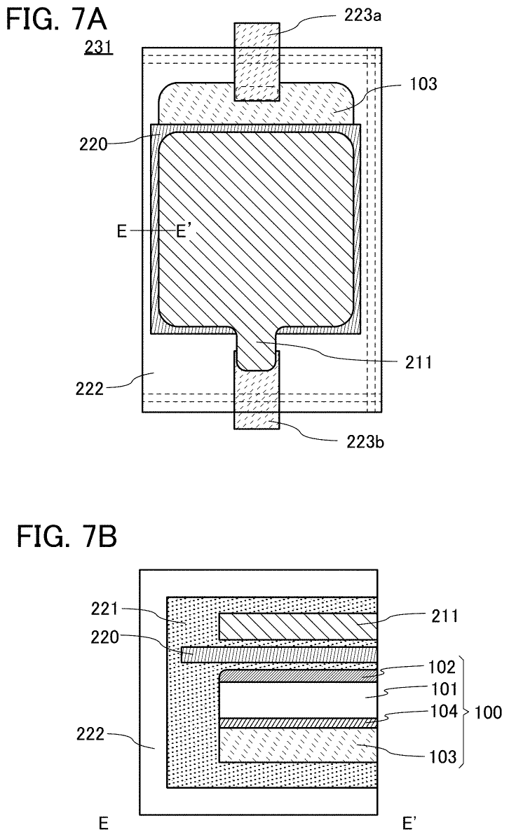

FIG. 7A and FIG. 7B illustrate a secondary battery 231 including an electrolytic solution and the negative electrode 211 serving as both a negative electrode current collector layer and a negative electrode active material layer. FIG. 7A is a top view, and FIG. 7B is a cross-sectional view taken along the line E-E′ in FIG. 7A.

As illustrated in FIG. 7B, the secondary battery 231 includes the positive electrode 100, the negative electrode 211 serving as both a negative electrode current collector layer and a negative electrode active material layer, the separator 220, the electrolytic solution 221, and the exterior body 222. With the negative electrode 211 serving as both a negative electrode current collector layer and a negative electrode active material layer, the secondary battery can be manufactured through a simplified process with high productivity. Moreover, the secondary battery can have high energy density.

### [Manufacturing Method]

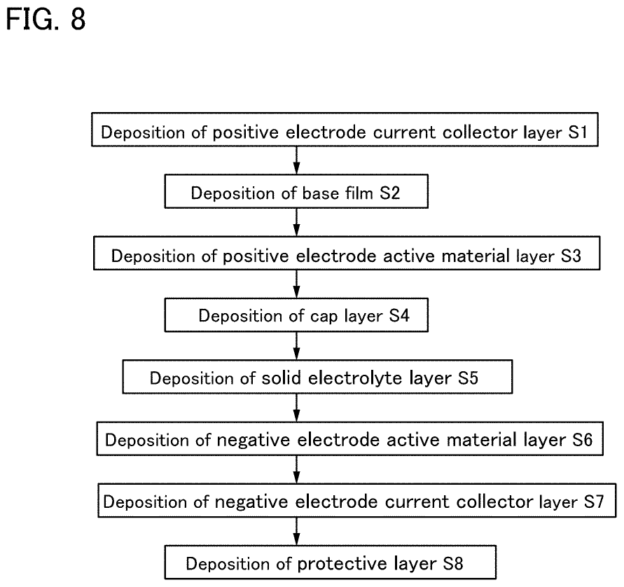

Next, a flow example of a method for manufacturing the secondary battery 200 illustrated in FIG. 4A and FIG. 4B will be described with reference to FIG. 8.

First, the positive electrode current collector 103 is formed over the substrate 110 (S1). As a deposition method, a sputtering method, an evaporation method, or the like can be used. A substrate having conductivity may be used as the current collector. For the positive electrode current collector 103, it is possible to use a material having high conductivity, for example, a metal such as gold, platinum, aluminum, titanium, copper, magnesium, iron, cobalt, nickel, zinc, germanium, indium, silver, or palladium or an alloy thereof. It is also possible to use aluminum to which an element that improves heat resistance, such as silicon, titanium, neodymium, scandium, or molybdenum, is added. Alternatively, the positive electrode current collector 103 may be formed using a metal element that forms silicide by reacting with silicon. Examples of the metal element that forms silicide by reacting with silicon include zirconium, titanium, hafnium, vanadium, niobium, tantalum, chromium, molybdenum, tungsten, cobalt, and nickel.

As the substrate 110, a ceramic substrate, a glass substrate, a resin substrate, a silicon substrate, a metal substrate, or the like can be used. When a flexible material is used for the substrate 110, a flexible thin-film secondary battery can be manufactured.

The positive electrode current collector 103 using a material having high conductivity can serve as both a substrate and a positive electrode current collector. In this case, a metal substrate of titanium or copper is preferably used, for example. In the case where the base film 104 is provided, the base film 104 inhibits oxidation of the positive electrode current collector 103 due to oxygen contained in the positive electrode active material layer 101 or the like or diffusion of metal atoms. Accordingly, a material that is easily oxidized or a material including a metal atom that is easily diffused can be used for the positive electrode current collector 103.

Next, the base film 104 is formed (S2). As a deposition method for the base film 104, a sputtering method, an evaporation method, or the like can be used. For example, in the case where titanium nitride is used for the base film 104, titanium nitride can be deposited by a reactive sputtering method using a titanium target and a nitrogen gas.

Then, the positive electrode active material layer 101 is formed (S3). The positive electrode active material layer 101 can be formed by a sputtering method using a sputtering target that includes, as its main component, an oxide containing lithium and one or more of manganese, cobalt, and nickel, for example. It is possible to use, for example, a sputtering target including lithium cobalt oxide (LiCoO₂, LiCo₂O₄, or the like) as its main component, a sputtering target including a lithium manganese oxide (LiMnO₂, LiMn₂O₄, or the like) as its main component, or a sputtering target including a lithium nickel oxide (LiNiO₂, LiNi₂O₄, or the like) as its main component. Alternatively, the positive electrode active material layer 101 may be formed by a vacuum evaporation method.

In a sputtering method, with use of a metal mask, film deposition can be selectively performed. Alternatively, the positive electrode active material layer 101 may be patterned by being selectively removed by dry etching or wet etching using a resist mask or the like.

To form the positive electrode active material layer 101 containing magnesium, fluorine, aluminum, or the like, the positive electrode active material layer 101 may be formed using a sputtering target that contains magnesium, fluorine, aluminum, or the like in addition to lithium and one or more of manganese, cobalt, and nickel. Alternatively, film deposition may be performed using a sputtering target that includes, as its main component, an oxide containing lithium and one or more of manganese, cobalt, and nickel; after that, magnesium, fluorine, aluminum, or the like may be deposited by a vacuum evaporation method; then, annealing may be performed.

Subsequently, the cap layer 102 is formed over the positive electrode active material layer 101 (S4). As a deposition method for the cap layer 102, a sputtering method, an evaporation method, or the like can be used. For example, in the case where titanium oxide is used for the cap layer 102, titanium oxide can be deposited by a reactive sputtering method using a titanium target and an oxygen gas. Titanium oxide can also be deposited by sputtering of a titanium oxide target.

The positive electrode active material layer 101 and the cap layer 102 are preferably formed at a high temperature (500° C. or higher). The positive electrode 100 with higher crystallinity can be manufactured.

Next, the solid electrolyte layer 203 is formed over the positive electrode active material layer 101 (S5).

A compound containing titanium is preferably used for the solid electrolyte layer 203. Since the cap layer 102 included in the positive electrode 100 contains titanium, the secondary battery can be easily manufactured when a material containing titanium is also used for the solid electrolyte layer 203. As a deposition method, a sputtering method, an evaporation method, or the like can be used.

Then, the negative electrode active material layer 204 is formed over the solid electrolyte layer 203 (S6). As a deposition method, a sputtering method, an evaporation method, or the like can be used.

Next, the negative electrode current collector 205 is formed over the negative electrode active material layer 204 (S7). As a material of the negative electrode current collector 205, one or more kinds of conductive materials selected from aluminum, titanium, copper, gold, chromium, tungsten, molybdenum, nickel, silver, and the like are used. As a deposition method, a sputtering method, an evaporation method, or the like can be used. In a sputtering method, with use of a metal mask, film deposition can be selectively performed. A conductive film may be patterned by being selectively removed by dry etching or wet etching using a resist mask or the like.

In the case where the positive electrode current collector 103 or the negative electrode current collector 205 is formed by a sputtering method, at least one of the positive electrode active material layer 101 and the negative electrode active material layer 204 is preferably formed by a sputtering method. A sputtering apparatus is capable of successive film deposition in one chamber or using a plurality of chambers and can also be a multi-chamber manufacturing apparatus or an in-line manufacturing apparatus. A sputtering method is a manufacturing method that uses a chamber and a sputtering target and is suitable for mass production. In addition, a sputtering method enables thin formation and thus excels in film deposition properties.

Then, the protective layer 206 is preferably formed over the positive electrode 100, the solid electrolyte layer 203, and the negative electrode 210 (S8). For the protective layer 206, it is possible to use a metal oxide containing one kind or two or more kinds selected from hafnium, aluminum, gallium, yttrium, zirconium, tungsten, titanium, tantalum, nickel, germanium, neodymium, lanthanum, magnesium, and the like. It is also possible to use silicon nitride oxide, silicon nitride, or the like. The protective layer 206 can be formed by a sputtering method.

For film deposition of each layer described in this embodiment, a gas phase method (a vacuum evaporation method, a thermal spraying method, a pulsed laser deposition method (PLD method), an ion plating method, a cold spray method, or an aerosol deposition method) can also be used without limitation to a sputtering method. Note that an aerosol deposition (AD) method is a method in which film deposition is performed without heating a substrate. The aerosol means microparticles dispersed in a gas. Alternatively, a CVD method or an ALD (Atomic Layer Deposition) method may be used.

Through the above-described steps, the secondary battery 200 of one embodiment of the present invention can be manufactured.

This embodiment can be implemented in appropriate combination with the other embodiments.

### Embodiment 3

In order to increase the output voltage of a thin-film secondary battery, secondary batteries can be connected in series. While the example of the secondary battery of the single cell is described in Embodiment 2, an example of manufacturing thin-film secondary batteries in which a plurality of cells are connected in series is described in this embodiment.

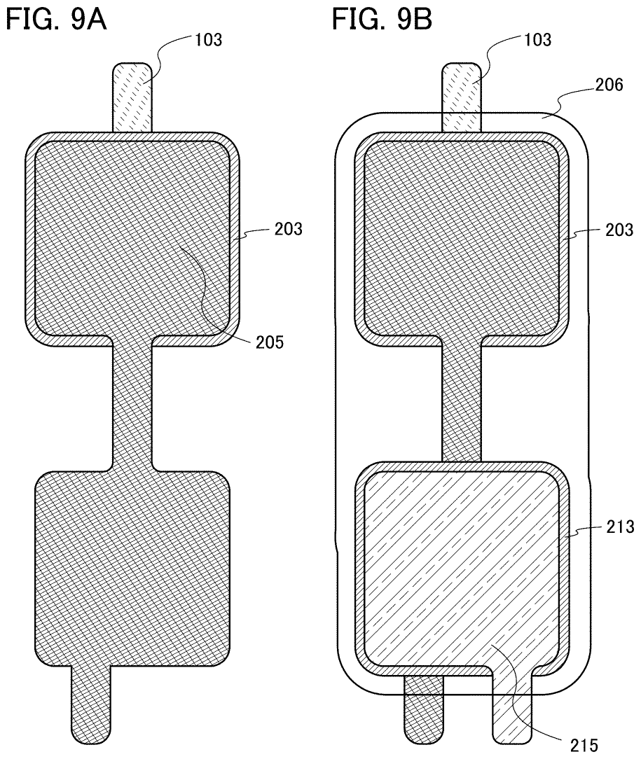

FIG. 9A is a top view right after formation of a first secondary battery, and FIG. 9B is a top view of two secondary batteries connected in series. In FIG. 9A and FIG. 9B, the same portions as the portions in FIG. 5A described in Embodiment 2 are denoted by the same reference numerals.

FIG. 9A illustrates the state right after deposition of the negative electrode current collector 205. The shape of the top surface of the negative electrode current collector 205 is different from that in FIG. 5A. The negative electrode current collector 205 illustrated in FIG. 9A is partly in contact with a side surface of a solid electrolyte layer and is also in contact with an insulating surface of a substrate.

Then, a second negative electrode active material layer, a second solid electrolyte layer 213, a second positive electrode active material layer, and a second positive electrode current collector 215 are formed in this order over a region of the negative electrode current collector 205 that does not overlap with a first negative electrode active material layer. Lastly, the protective layer 206 is formed (FIG. 9B).

FIG. 9B illustrates a structure in which two solid-state secondary batteries are arranged on a plane and connected in series.

This embodiment can be implemented in appropriate combination with the other embodiments.

### Embodiment 4

A plurality of positive electrodes and a plurality of negative electrodes can be stacked to form a multi-layer secondary battery to increase an output voltage or a discharge capacity of a thin-film secondary battery. While the example of the secondary battery of the single-layer cell is described in Embodiment 2, an example of a thin-film battery of a multi-layer cell is described in this embodiment.

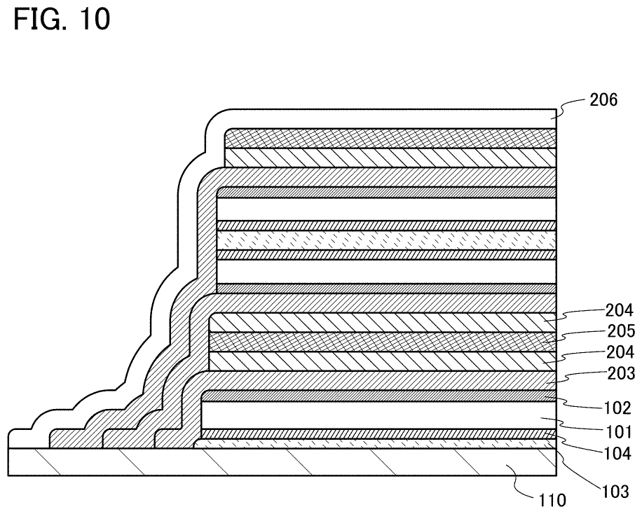

FIG. 10 is an example of a cross section of a thin-film battery of a three-layer cell. A first cell is formed in such a manner that the positive electrode current collector 103 is formed over the substrate 110, and the base film 104, the positive electrode active material layer 101, the cap layer 102, the solid electrolyte layer 203, the negative electrode active material layer 204, and the negative electrode current collector 205 are sequentially formed over the positive electrode current collector 103.

Furthermore, a second cell is formed in such a manner that a second negative electrode active material layer 204, a solid electrolyte layer, a cap layer, a positive electrode active material layer, a base film, and a positive electrode current collector layer are sequentially formed over the negative electrode current collector 205.

Moreover, a third cell is formed in such a manner that a third base film, a positive electrode active material layer, a cap layer, a solid electrolyte layer, a negative electrode active material layer, and a negative electrode current collector layer are sequentially formed over the second positive electrode current collector.

Lastly, the protective layer 206 is formed in FIG. 10. The three-layer stack illustrated in FIG. 10 has a structure of series connection in order to increase the capacity but can be connected in parallel with an external wiring. Series connection, parallel connection, or series-parallel connection can also be selected with an external wiring.

Note that the solid electrolyte layer 203, the second solid electrolyte layer, and the third solid electrolyte layer are preferably formed using the same material, leading to a reduction in the manufacturing cost.

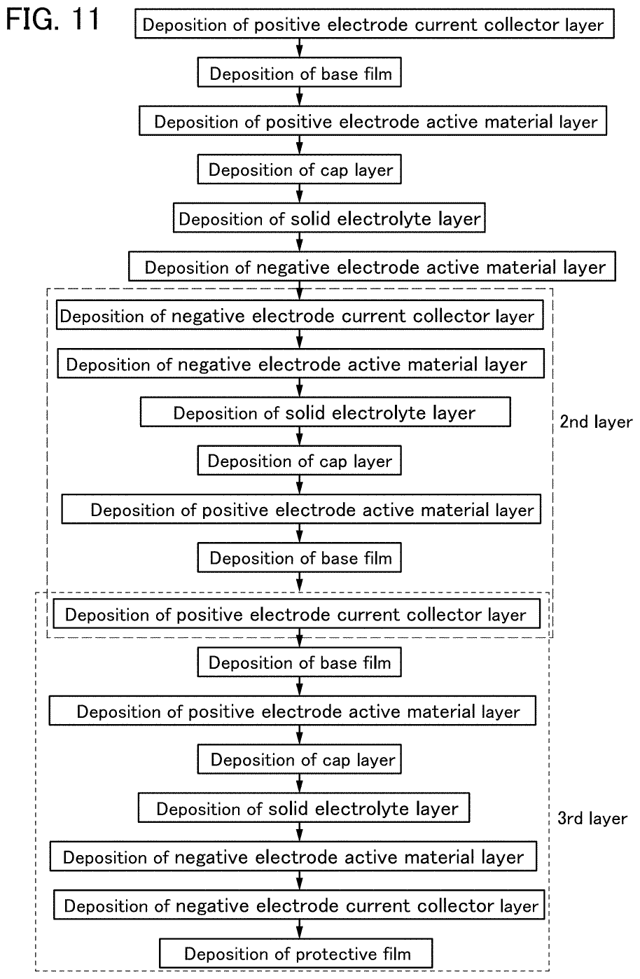

FIG. 11 shows an example of a manufacturing flow for obtaining the structure illustrated in FIG. 10.

To reduce the number of manufacturing steps, in FIG. 11, it is preferable to use a lithium cobalt oxide film for the positive electrode active material layer and to use a titanium film for the positive electrode current collector and the negative electrode current collector (conductive layer). The use of the titanium film as a common electrode allows a three-layer stacked cell with a small number of components to be achieved.

This embodiment can be implemented in appropriate combination with the other embodiments.

### Embodiment 5

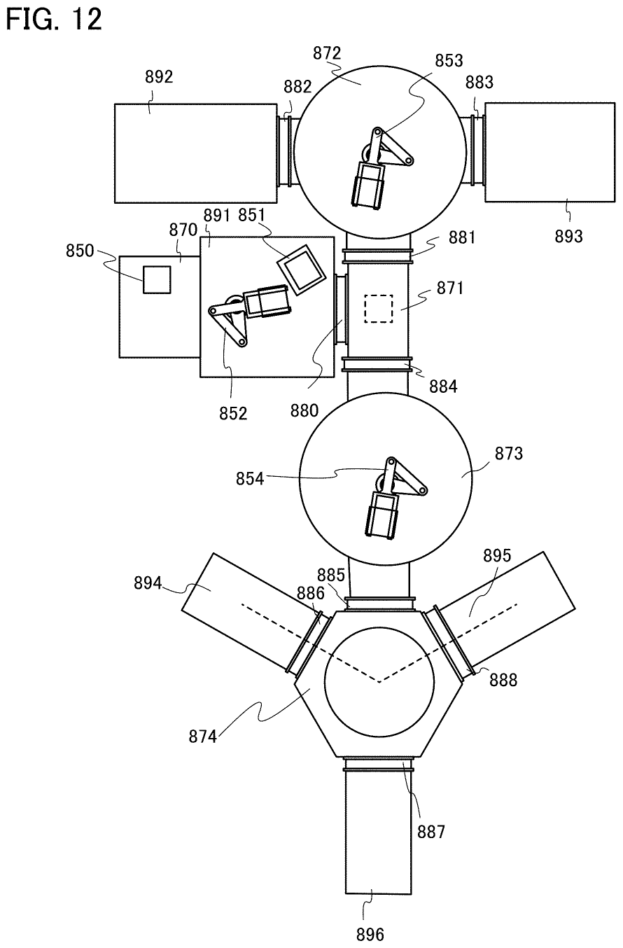

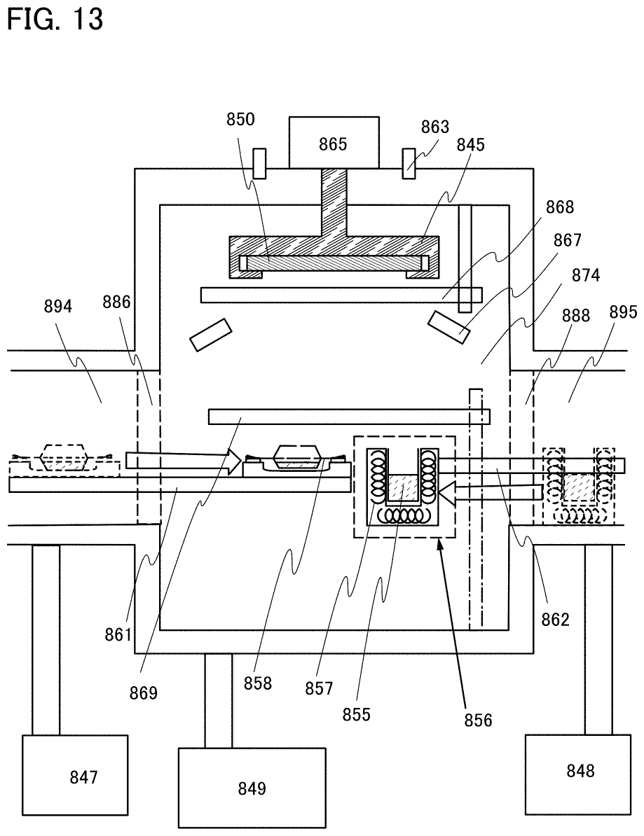

In this embodiment, FIG. 12 and FIG. 13 illustrate an example of a multi-chamber manufacturing apparatus capable of totally automating the manufacture from a positive electrode current collector layer to a negative electrode current collector layer in a secondary battery. The manufacturing apparatus can be suitably used for manufacturing the thin-film secondary battery of one embodiment of the present invention.

FIG. 12 illustrates an example of a multi-chamber manufacturing apparatus that includes gates 880, 881, 882, 883, 884, 885, 886, 887, and 888, a load lock chamber 870, a mask alignment chamber 891, a first transfer chamber 871, a second transfer chamber 872, a third transfer chamber 873, a plurality of deposition chambers (a first deposition chamber 892 and a second deposition chamber 874), a heating chamber 893, a second material supply chamber 894, a first material supply chamber 895, and a third material supply chamber 896.

The mask alignment chamber 891 includes at least a stage 851 and a substrate transfer mechanism 852.

The first transfer chamber 871 includes a substrate cassette raising and lowering mechanism, the second transfer chamber 872 includes a substrate transfer mechanism 853, and the third transfer chamber 873 includes a substrate transfer mechanism 854.

Each of the first deposition chamber 892, the second deposition chamber 874, the second material supply chamber 894, the first material supply chamber 895, the third material supply chamber 896, the mask alignment chamber 891, the first transfer chamber 871, the second transfer chamber 872, and the third transfer chamber 873 is connected to an exhaust mechanism. The exhaust mechanism is selected in accordance with usage of the respective chambers, and may be, for example, an exhaust mechanism including a pump having an adsorption unit, such as a cryopump, a sputtering ion pump, or a titanium sublimation pump, an exhaust mechanism including a turbo molecular pump provided with a cold trap, or the like.

In a process of film deposition on the substrate, the substrate 850 or the substrate cassette is set in the load lock chamber 870, and transferred to the mask alignment chamber 891 by the substrate transfer mechanism 852. A mask to be used is picked up among a plurality of masks set in advance in the mask alignment chamber 891, and its position is aligned with the substrate over the stage 851. After the position alignment, the gate 880 is opened, and the mask and the substrate 850 are transferred to the first transfer chamber 871 by the substrate transfer mechanism 852. After the mask and the substrate 850 are transferred to the first transfer chamber 871, the gate 881 is opened, and they are transferred to the second transfer chamber 872 by the substrate transfer mechanism 853.

The first deposition chamber 892 provided next to the second transfer chamber 872 through the gate 882 is a sputtering deposition chamber. The sputtering deposition chamber has a mechanism of applying voltage to the sputtering target by switching an RF power supply and a pulsed DC power supply. Furthermore, two or three kinds of sputtering targets can be set. In this embodiment, a single crystal silicon target, a sputtering target including lithium cobalt oxide (LiCoO₂) as its main component, and a titanium target are set. It is possible to provide a substrate heating mechanism in the first deposition chamber 892 and perform film deposition while heating is performed up to a heater temperature of 700° C.

The negative electrode active material layer can be formed by a sputtering method using a single crystal silicon target. An SiOₓ film formed by a reactive sputtering method using an Ar gas and an O₂ gas may be used as the negative electrode active material layer. A silicon nitride film formed by a reactive sputtering method using an Ar gas and an N₂ gas can be used as a sealing film. The positive electrode active material layer can be formed by a sputtering method using a sputtering target including lithium cobalt oxide (LiCoO₂) as its main component. A conductive film to be a current collector can be formed by a sputtering method using a titanium target. A titanium nitride film formed by a reactive sputtering method using an Ar gas and an N₂ gas can be formed as the cap layer or the base film.

In the case where the positive electrode active material layer is formed, the mask and the substrate in an overlapped state are transferred from the second transfer chamber 872 to the first deposition chamber 892 by the substrate transfer mechanism 853, the gate 882 is closed, and then film deposition is performed by a sputtering method. After the deposition, the gate 882 and the gate 883 are opened, transferring to the heating chamber 893 is performed, the gate 883 is closed, and then heating can be performed. For this heat treatment in the heating chamber 893, an RTA (Rapid Thermal Anneal) apparatus, a resistance heating furnace, or a microwave heating apparatus can be used. As the RTA apparatus, a GRTA (Gas Rapid Thermal Anneal) apparatus or an LRTA (Lamp Rapid Thermal Anneal) apparatus can be used. The heat treatment in the heating chamber 893 can be performed in an atmosphere of nitrogen, oxygen, a rare gas, or dry air. In addition, heating time is longer than or equal to 1 minute and shorter than or equal to 24 hours.

After the film deposition or the heat treatment, the substrate and the mask are returned to the mask alignment chamber 891 and position alignment for a new mask is performed. The substrate and the mask after being subjected to the position alignment are transferred to the first transfer chamber 871 by the substrate transfer mechanism 852. The substrate is transferred by the raising and lowering mechanism of the first transfer chamber 871, the gate 884 is opened, and transferring to the third transfer chamber 873 is performed by the substrate transfer mechanism 854.

In the second deposition chamber 874 which is connected to the third transfer chamber 873 through the gate 885, film deposition by evaporation is performed.

FIG. 13 illustrates an example of a cross-sectional structure of the second deposition chamber 874. FIG. 13 is a schematic cross-sectional view taken along the dotted line in FIG. 12. The second deposition chamber 874 is connected to the exhaust mechanism 849, and the first material supply chamber 895 is connected to the exhaust mechanism 848. The second material supply chamber 894 is connected to the exhaust mechanism 847. The second deposition chamber 874 illustrated in FIG. 13 is an evaporation chamber where evaporation is performed using an evaporation source 856 that is transferred from the first material supply chamber 895. Evaporation sources are transferred from a plurality of material supply chambers and evaporation by vaporizing a plurality of substances at the same time, that is, co-evaporation can be performed. FIG. 13 illustrates an evaporation source including an evaporation boat 858 transferred from the second material supply chamber 894.

The second deposition chamber 874 is connected to the second material supply chamber 894 through the gate 886. The second deposition chamber 874 is connected to the first material supply chamber 895 through the gate 888. The second deposition chamber 874 is connected to the third material supply chamber 896 through the gate 887. Thus, ternary co-evaporation is possible in the second deposition chamber 874.

In a process of evaporation, first, the substrate is provided in a substrate holding portion 845. The substrate holding portion 845 is connected to a rotation mechanism 865. Then, a first evaporation material 855 is heated to some extent in the first material supply chamber 895, the gate 888 is opened when the evaporation rate becomes stable, and an arm 862 is extended so that the evaporation source 856 is transferred and stopped below the substrate. The evaporation source 856 includes the first evaporation material 855, a heater 857, and a container for storing the first evaporation material 855. Also in the second material supply chamber 894, a second evaporation material is heated to some extent, the gate 886 is opened when the evaporation rate becomes stable, and an arm 861 is extended so that the evaporation source is transferred and stopped below the substrate.

After that, a shutter 868 and an evaporation source shutter 869 are opened, and co-evaporation is performed. During the evaporation, the rotation mechanism 865 is rotated in order to improve the uniformity of the thickness. The substrate after being subjected to the evaporation is transferred to the mask alignment chamber 891 on the same route. In the case where the substrate is extracted from the manufacturing apparatus, the substrate is transferred from the mask alignment chamber 891 to the load lock chamber 870 and extracted.

FIG. 13 illustrates an example where the substrate 850 and a mask are held by the substrate holding portion 845. The substrate 850 (and the mask) is rotated by a substrate rotation mechanism, so that uniformity of film deposition can be increased. The substrate rotation mechanism may also serve as a substrate transfer mechanism.

The second deposition chamber 874 may include an imaging unit 863 such as a CCD camera. With the provision of the imaging unit 863, the position of the substrate 850 can be confirmed.

In the second deposition chamber 874, the thickness of a film deposited on a substrate surface can be estimated from results of measurements by a film thickness measurement mechanism 867. The film thickness measurement mechanism 867 may include a crystal oscillator, for example.

Note that in order to control the evaporation of the vaporized evaporation material, the shutter 868 is provided so as to overlap with the substrate until the vaporization rate of the evaporation material becomes stable, and the evaporation source shutter 869 is provided to overlap with the evaporation source 856 and the evaporation boat 858 until the vaporization rate of the evaporation material becomes stable.

In the evaporation source 856, an example of a resistance heating method is shown, but an EB (Electron Beam) evaporation method may be employed. In addition, although an example of a crucible as the container for the evaporation source 856 is shown, an evaporation boat may be used. As the first evaporation material 855, an organic material is put into the crucible heated by the heater 857. In the case where pellet-like or particle-like SiO or the like is used as the evaporation material, the evaporation boat 858 is used. The evaporation boat 858 is composed of three parts, and obtained by overlapping a member having a concave surface, a middle lid having two openings, and a top lid having one opening. Note that the evaporation may be performed after the middle lid is removed. The evaporation boat 858 functions as a resistor when current flows therethrough, and has a mechanism of heating itself.

Although an example of a multi-chamber apparatus is described in this embodiment, there is no particular limitation and an in-line manufacturing apparatus may be used.

This embodiment can be implemented in appropriate combination with the other embodiments.

### Embodiment 6

In this embodiment, an example of a thin-film secondary battery including a battery control circuit or the like is described.

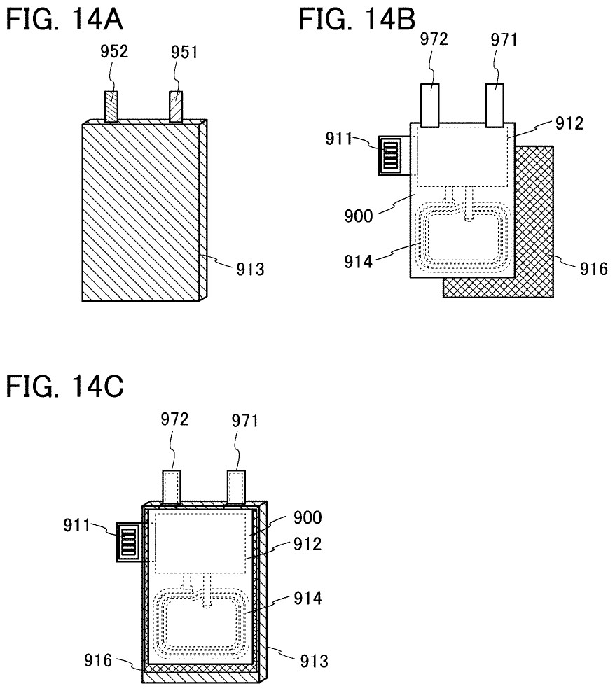

FIG. 14A is an external view of a thin-film secondary battery. A secondary battery 913 includes a terminal 951 and a terminal 952. The terminal 951 and the terminal 952 are electrically connected to a positive electrode and a negative electrode, respectively. The secondary battery of one embodiment of the present invention has excellent cycle performance. In addition, the level of safety is high because of an all-solid-state secondary battery. Therefore, the secondary battery of one embodiment of the present invention can be suitably used as the secondary battery 913.

FIG. 14B is an external view of a battery control circuit. A battery control circuit illustrated in FIG. 14B includes a substrate 900 and a layer 916. A circuit 912 and an antenna 914 are provided over the substrate 900. The antenna 914 is electrically connected to the circuit 912. A terminal 971 and a terminal 972 are electrically connected to the circuit 912. The circuit 912 is electrically connected to a terminal 911.

The terminal 911 is connected to a device to which electric power of the thin-film-type solid-state secondary battery is supplied, for example. For example, the terminal 911 is connected to a display device, a sensor, or the like.

The layer 916 has a function of blocking an electromagnetic field from the secondary battery 913, for example. As the layer 916, for example, a magnetic body can be used.

FIG. 14C shows an example in which the battery control circuit illustrated in FIG. 14B is provided over the secondary battery 913. The terminal 971 and the terminal 972 are electrically connected to the terminal 951 and the terminal 952, respectively. The layer 916 is provided between the substrate 900 and the secondary battery 913.

A substrate having flexibility is preferably used as the substrate 900.

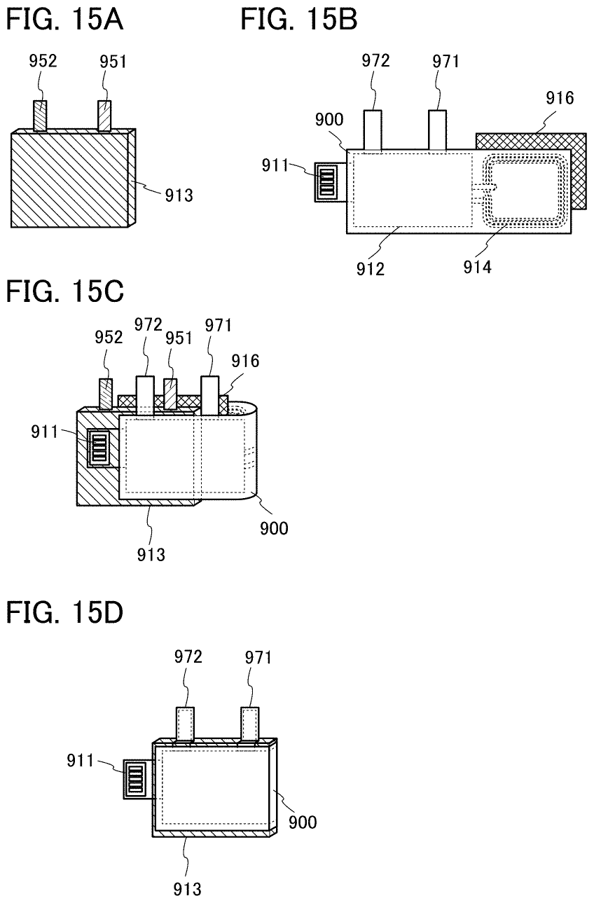

By using a substrate having flexibility as the substrate 900, a thin battery control circuit can be achieved. As illustrated in FIG. 15D described later, the battery control circuit can be wound around the secondary battery.

Another example of a thin-film secondary battery including a battery control circuit or the like is described with reference to FIG. 15A to FIG. 15D. FIG. 15A is an external view of a thin-film-type solid-state secondary battery. A battery control circuit illustrated in FIG. 15B includes the substrate 900 and the layer 916.

As illustrated in FIG. 15C, the substrate 900 is bent to fit the shape of the secondary battery 913, and the battery control circuit is provided around the secondary battery, whereby the battery control circuit can be wound around the secondary battery as illustrated in FIG. 15D. With such a structure, the secondary battery can be downsized.

This embodiment can be implemented in appropriate combination with the other embodiments.

### Embodiment 7

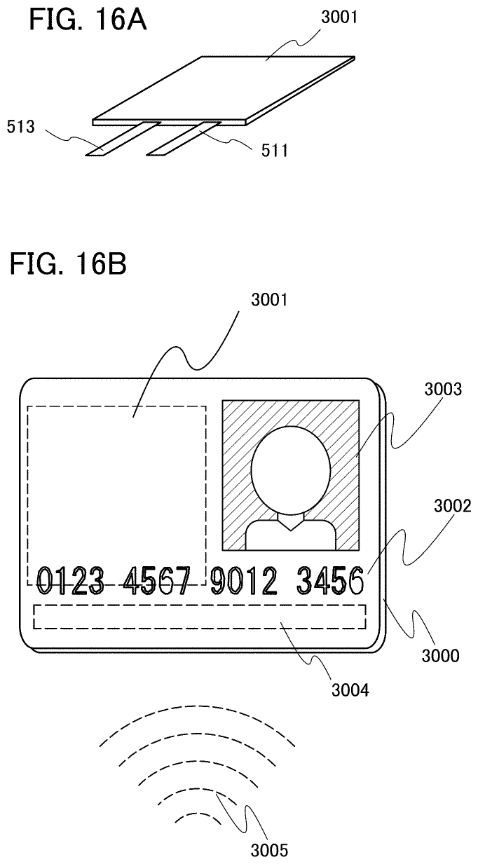

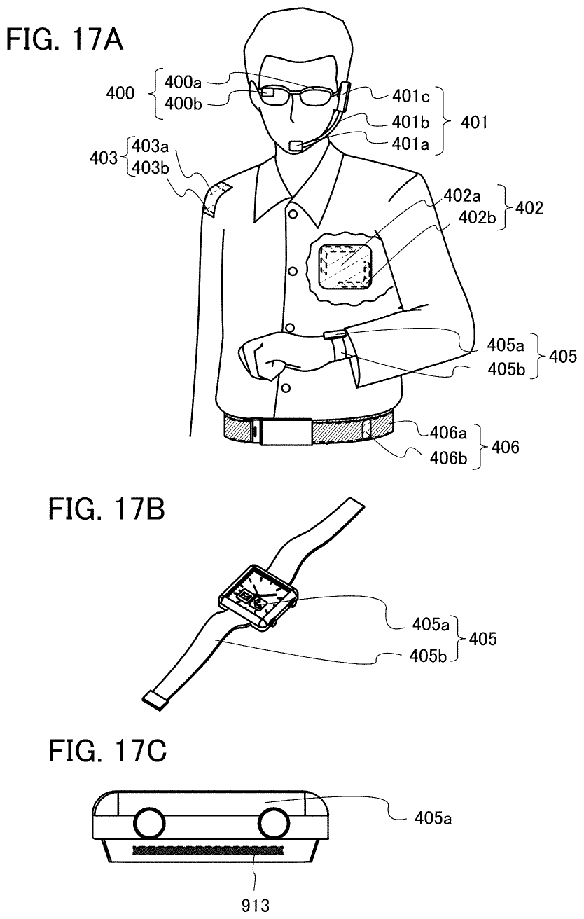

In this embodiment, examples of electronic devices using thin-film secondary batteries are described with reference to FIG. 16A, FIG. 16B, and FIG. 17A to FIG. 17C. The secondary battery of one embodiment of the present invention has a high discharge capacity, a high cycle performance, and a high level of safety. Thus, the electronic devices have a high level of safety and can be used for a long time.

FIG. 16A is an external perspective view of a thin-film-type secondary battery 3001 of the present invention. The thin-film-type secondary battery 3001 is subjected to sealing with a laminate film or an insulating material such that a positive electrode lead electrode 513 electrically connected to a positive electrode of a solid-state secondary battery and a negative electrode lead electrode 511 electrically connected to a negative electrode project.

FIG. 16B illustrates an IC card which is an example of an application device using a thin-film-type secondary battery of the present invention. The thin-film-type secondary battery 3001 can be charged with electric power obtained by power feeding from a radio wave 3005. In an IC card 3000, an antenna, an IC 3004, and the thin-film-type secondary battery 3001 are provided.

An ID 3002 and a photograph 3003 of a worker who wears a management badge are displayed on the IC card 3000. A signal such as an authentication signal can be transmitted from the antenna using the electric power charged in the thin-film-type secondary battery 3001.

An active matrix display device may be provided to display the ID 3002 and the photograph 3003. As examples of the active matrix display device, a reflective liquid crystal display device, an organic EL display device, electronic paper, or the like can be given. An image (a moving image or a still image) or time can be displayed on the active matrix display device. Electric power for the active matrix display device can be supplied from the thin-film-type secondary battery 3001.

A plastic substrate is used for the IC card, and thus an organic EL display device using a flexible substrate is preferable.

A solar cell may be provided instead of the photograph 3003. By irradiation with external light, light can be absorbed to generate electric power, and the thin-film-type secondary battery 3001 can be charged with the electric power.

Without limitation to the IC card, the thin-film-type secondary battery can be used for a power supply of an in-vehicle wireless sensor, a secondary battery for a MEMS device, or the like.

FIG. 17A illustrates examples of wearable devices. A secondary battery is used as a power supply of a wearable device in some cases. To have improved splash resistance, water resistance, or dust resistance in daily use or outdoor use by a user, a wearable device is desirably capable of being charged wirelessly as well as being charged with a wire whose connector portion for connection is exposed.

For example, the secondary battery of one embodiment of the present invention can be incorporated in a glasses-type device 400 as illustrated in FIG. 17A. The glasses-type device 400 includes a frame 400a and a display portion 400b. A secondary battery is incorporated in a temple of the frame 400a having a curved shape, whereby the glasses-type device 400 can be lightweight, have a well-balanced weight, and be used continuously for a long time. When the secondary battery of one embodiment of the present invention is included, a structure that can support space saving due to a reduction in the size of a housing can be achieved.

Furthermore, the secondary battery of one embodiment of the present invention can be incorporated in a headset-type device 401. The headset-type device 401 includes at least a microphone portion 401a, a flexible pipe 401b, and an earphone portion 401c. The secondary battery can be provided in the flexible pipe 401b or the earphone portion 401c. When the secondary battery of one embodiment of the present invention is included, a structure that can support space saving due to a reduction in the size of a housing can be achieved.

The secondary battery of one embodiment of the present invention can also be incorporated in a device 402 that can be directly attached to a human body. A secondary battery 402b can be provided in a thin housing 402a of the device 402. When the secondary battery of one embodiment of the present invention is included, a structure that can support space saving due to a reduction in the size of a housing can be achieved.

The secondary battery of one embodiment of the present invention can also be incorporated in a device 403 that can be attached to clothing. A secondary battery 403b can be provided in a thin housing 403a of the device 403. When the secondary battery of one embodiment of the present invention is included, a structure that can support space saving due to a reduction in the size of a housing can be achieved.

Furthermore, the secondary battery of one embodiment of the present invention can be incorporated in a belt-type device 406. The belt-type device 406 includes a belt portion 406a and a wireless power feeding and receiving portion 406b, and the secondary battery can be incorporated in the belt portion 406a. When the secondary battery of one embodiment of the present invention is included, a structure that can support space saving due to a reduction in the size of a housing can be achieved.

The secondary battery of one embodiment of the present invention can also be incorporated in a watch-type device 405. The watch-type device 405 includes a display portion 405a and a belt portion 405b, and the secondary battery can be provided in the display portion 405a or the belt portion 405b. When the secondary battery of one embodiment of the present invention is included, a structure that can support space saving due to a reduction in the size of a housing can be achieved.

The display portion 405a can display various kinds of information such as reception information of an e-mail or an incoming call in addition to time.

Since the watch-type device 405 is a type of wearable device that is directly wrapped around an arm, a sensor that measures pulse, blood pressure, or the like of a user can be incorporated therein. Data on the exercise quantity and health of the user can be accumulated and used for health maintenance.

FIG. 17B shows a perspective view of the watch-type device 405 that is detached from an arm.

FIG. 17C shows a side view of the watch-type device 405. FIG. 17C illustrates a state where the secondary battery 913 is incorporated inside. The secondary battery 913 is the secondary battery described in Embodiment 5. The secondary battery 913 is provided to overlap with the display portion 405a and is small and lightweight.

This embodiment can be implemented in appropriate combination with the other embodiments.

### Embodiment 8

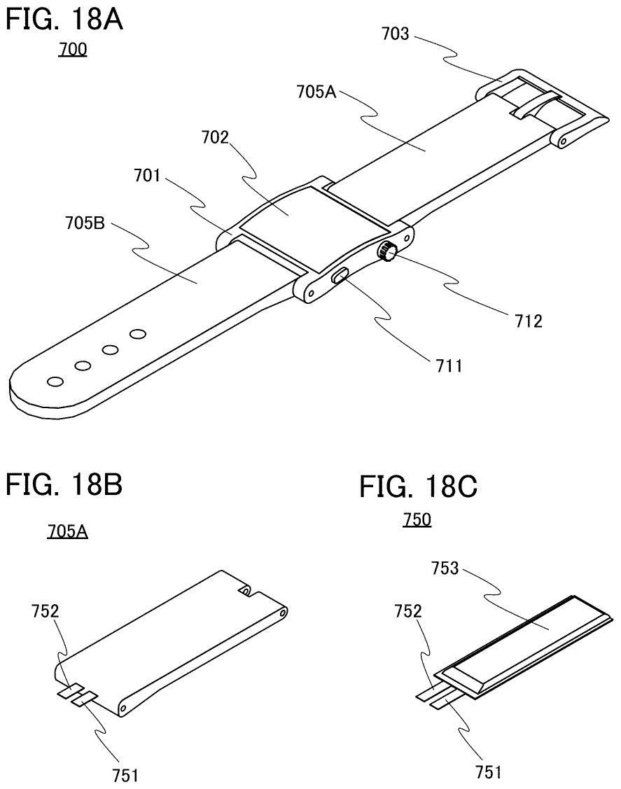

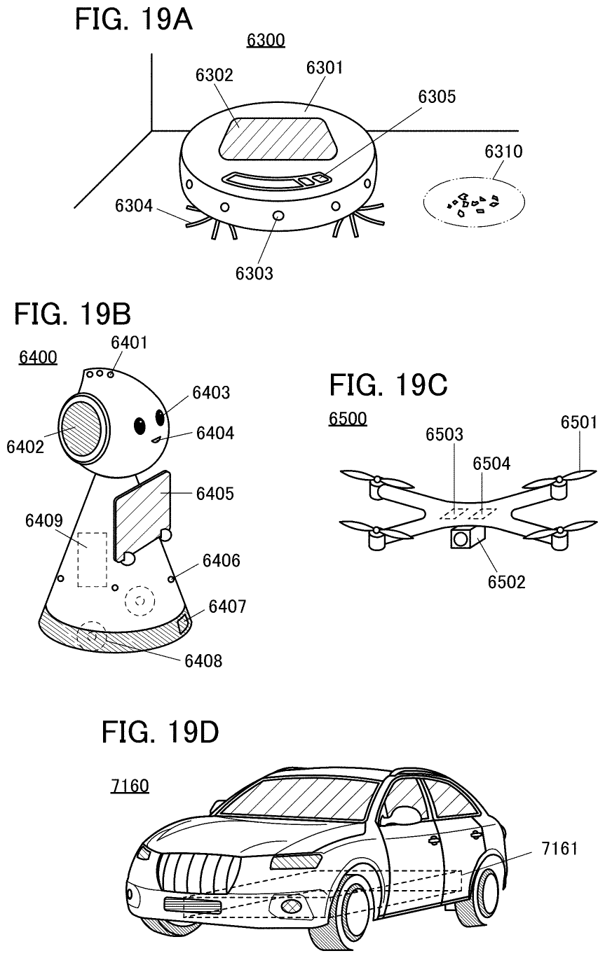

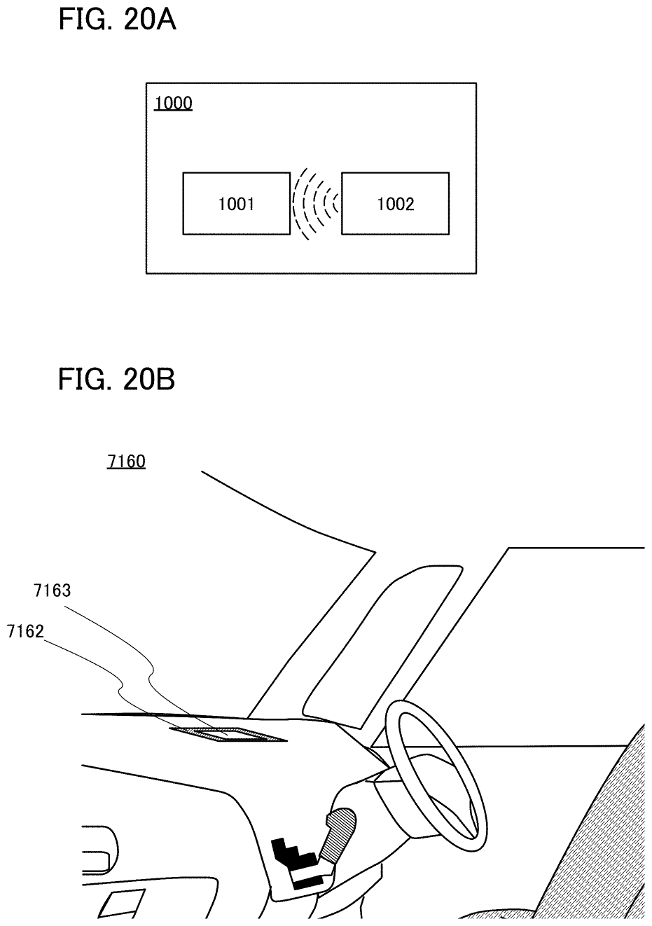

In this embodiment, electronic devices each using the secondary battery including the positive electrode of one embodiment of the present invention are described with reference to FIG. 18A to FIG. 18C, FIG. 19A to FIG. 19D, and FIG. 20A and FIG. 20B. The secondary battery including the positive electrode of one embodiment of the present invention has a high discharge capacity, a high cycle performance, and a high level of safety. Such a secondary battery can be favorably used for electronic devices given below. The secondary battery can be favorably used particularly for an electronic device that is required to have durability.

FIG. 18A is a perspective view of a watch-type portable information terminal (also called a smartwatch) 700. The portable information terminal 700 includes a housing 701, a display panel 702, a clasp 703, bands 705A and 705B, and operation buttons 711 and 712.

The display panel 702 mounted in the housing 701 doubling as a bezel includes a rectangular display region. The display region has a curved surface. The display panel 702 preferably has flexibility. Note that the display region may be non-rectangular.

The bands 705A and 705B are connected to the housing 701. The clasp 703 is connected to the band 705A. The band 705A and the housing 701 are connected such that a connection portion rotates via a pin. In a similar manner, the band 705B and the housing 701 are connected to each other and the band 705A and the clasp 703 are connected to each other.

FIG. 18B and FIG. 18C are perspective views of the band 705A and a secondary battery 750, respectively. The band 705A includes the secondary battery 750. As the secondary battery 750, the secondary battery described in the foregoing embodiment can be used, for example. The secondary battery 750 is embedded in the band 705A, and a positive electrode lead 751 and a negative electrode lead 752 partly protrude from the band 705A (see FIG. 18B). The positive electrode lead 751 and the negative electrode lead 752 are electrically connected to the display panel 702. The surface of the secondary battery 750 is covered with an exterior body 753 (see FIG. 18C). Note that the pin may function as an electrode. Specifically, through the pin that connects the band 705A and the housing 701, the positive electrode lead 751 and the display panel 702 may be electrically connected to each other and the negative electrode lead 752 and the display panel 702 may be electrically connected to each other. This simplifies the structure of the connection portion between the band 705A and the housing 701.

The secondary battery 750 has flexibility. Thus, the band 705A can be formed so as to incorporate the secondary battery 750. For example, the secondary battery 750 is set in a mold that the outside shape of the band 705A fits and a material of the band 705A is poured in the mold and cured, so that the band 705A illustrated in FIG. 18B can be formed.

In the case where a rubber material is used as the material for the band 705A, rubber is cured through heat treatment. For example, in the case where fluorine rubber is used as a rubber material, it is cured through heat treatment at 170° C. for 10 minutes. In the case where silicone rubber is used as a rubber material, it is cured through heat treatment at 150° C. for 10 minutes.

Examples of the material used for the band 705A include fluorine rubber, silicone rubber, fluorosilicone rubber, and urethane rubber.

Note that the portable information terminal 700 illustrated in FIG. 18A can have a variety of functions such as a function of displaying a variety of data (e.g., a still image, a moving image, and a text image) on the display region, a touch panel function, a function of displaying a calendar, date, time, and the like, a function of controlling processing with a variety of software (programs), a wireless communication function, a function of being connected to a variety of computer networks with a wireless communication function, a function of transmitting and receiving a variety of data with a wireless communication function, and a function of reading out a program or data stored in a recording medium and displaying it on the display region.

The housing 701 can include a speaker, a sensor (a sensor having a function of measuring force, displacement, position, speed, acceleration, angular velocity, rotational frequency, distance, light, liquid, magnetism, temperature, chemical substance, sound, time, hardness, electric field, current, voltage, electric power, radiation, flow rate, humidity, gradient, oscillation, odor, or infrared rays), a microphone, and the like. Note that the portable information terminal 700 can be manufactured using a light-emitting element for the display panel 702.

Although FIG. 18A illustrates the example where the secondary battery 750 is incorporated in the band 705A, the secondary battery 750 may be incorporated in the band 705B. The band 705B can be formed using a material similar to that for the band 705A.

FIG. 19A illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a variety of sensors, and the like. Although not illustrated, the cleaning robot 6300 is provided with a tire, an inlet, and the like. The cleaning robot 6300 can run autonomously, detect dust 6310, and vacuum the dust through the inlet provided on a bottom surface.

For example, the cleaning robot 6300 can analyze images taken by the cameras 6303 to judge whether there are obstacles such as a wall, furniture, or a step. When an object that is likely to be caught in the brush 6304, such as a wire, is detected by image analysis, the rotation of the brush 6304 can be stopped. The cleaning robot 6300 internally includes the secondary battery of one embodiment of the present invention and a semiconductor device or an electronic component. The cleaning robot 6300 including the secondary battery of one embodiment of the present invention can be a highly reliable electronic device that can operate for a long time.

FIG. 19B illustrates an example of a robot. A robot 6400 illustrated in FIG. 19B includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with a user with the use of the microphone 6402 and the speaker 6404.

The display portion 6405 has a function of displaying various kinds of information. The robot 6400 can display information desired by a user on the display portion 6405. A touch panel may be incorporated in the display portion 6405. Moreover, the display portion 6405 may be a detachable information terminal, in which case charging and data communication can be performed when the display portion 6405 is set at the home position of the robot 6400.

The upper camera 6403 and the lower camera 6406 each have a function of taking images of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 internally includes the secondary battery 6409 of one embodiment of the present invention and a semiconductor device or an electronic component. The robot 6400 including the secondary battery of one embodiment of the present invention can be a highly reliable electronic device that can operate for a long time.

FIG. 19C illustrates an example of a flying object. A flying object 6500 illustrated in FIG. 19C includes propellers 6501, a camera 6502, a secondary battery 6503, and the like and has a function of flying autonomously.

For example, image data taken by the camera 6502 is stored in an electronic component 6504. The electronic component 6504 can analyze the image data to detect whether there are obstacles when the flying object moves. Moreover, the electronic component 6504 can estimate the remaining battery level from a change in the power storage capacity of the secondary battery 6503. The flying object 6500 internally includes the secondary battery 6503 of one embodiment of the present invention. The flying object 6500 including the secondary battery of one embodiment of the present invention can be a highly reliable electronic device that can operate for a long time.

FIG. 19D illustrates an example of an automobile. An automobile 7160 includes a secondary battery 7161, an engine, tires, a brake, a steering gear, a camera, and the like. The automobile 7160 preferably includes a system 1000 described later. The automobile 7160 internally includes the secondary battery 7161 of one embodiment of the present invention. The automobile 7160 using the secondary battery of one embodiment of the present invention can be a high-mileage automobile with a high level of safety and high reliability.

One embodiment of the present invention may be an electronic device or a system including the thin-film battery described in the foregoing embodiment and another secondary battery. There is no particular limitation on the other secondary battery; for example, a lithium-ion secondary battery including a positive electrode, a negative electrode, an electrolytic solution, and a separator, or a bulk all-solid-state secondary battery can be used. Note that in this specification and the like, a system refers to a system combining individual components. A secondary battery is included as one of the components.

FIG. 20A illustrates the system 1000 including a thin-film battery 1001 described in the foregoing embodiment, and a lithium-ion secondary battery 1002 including a positive electrode, a negative electrode, an electrolytic solution, and a separator. Such an electronic device or a system can have both the advantage of a secondary battery, which has a higher discharge capacity, and the advantage of a thin-film battery described in the foregoing embodiment, which is easily made thin and lightweight. The system 1000 preferably includes a wireless power feeding device. With the wireless power feeding device, electric power can be easily supplied from the lithium-ion secondary battery 1002 to the thin-film battery 1001.

FIG. 20B illustrates the inside of an automobile 7160 including the system 1000. The automobile 7160 includes a driving secondary battery, a wireless power feeding device 7162, and a key 7163. When the key 7163 is placed over the wireless power feeding device 7162, electric power can be supplied from the driving secondary battery 7161 to the key 7163. Although FIG. 20B shows an example in which the wireless power feeding device 7162 is provided on a dashboard, one embodiment of the present invention is not limited thereto. A storage place of the key 7163 may be provided in another place around a driver's seat, and the wireless power feeding device 7162 may be provided in the storage place.

At this time, the key 7163 preferably includes the thin-film battery described in the foregoing embodiment, in which case the key can be made thinner and more lightweight. As a secondary battery for driving the automobile 7160, a secondary battery that can easily have higher discharge capacity, e.g., a lithium-ion secondary battery including a positive electrode, a negative electrode, an electrolytic solution, and a separator, or a bulk all-solid-state secondary battery is preferably used.

This embodiment can be implemented in appropriate combination with the other embodiments.

### Embodiment 9

A device described in this embodiment includes at least a biosensor and a solid-state secondary battery that supplies electric power to the biosensor, and can obtain various kinds of biological data using infrared light and visible light and make the memory store the data. Such biological data can be used for both user's personal authentication uses and health care uses. The secondary battery of one embodiment of the present invention has a high discharge capacity, a high cycle performance, and a high level of safety. Thus, the device has a high level of safety and can be used for a long time.

The biosensor is a sensor for obtaining biological data and obtains biological data that can be used for health care uses. Examples of biological data include pulse waves, blood glucose levels, oxygen saturation levels, and neutral fat concentrations. The data is stored in the memory.

Furthermore, the device described in this embodiment is preferably provided with a unit for obtaining other biological data. Examples of such biological data include internal biological data such as an electrocardiogram, a blood pressure, and a body temperature and superficial biological data such as facial expression, a complexion, and a pupil. In addition, data on the number of steps taken, exercise intensity, a height difference in a movement, and a meal (e.g., calorie intake and nutrients) are important for health care. The use of a plurality of kinds of biological data and the like enables complex management of physical conditions, leading to not only daily health management but also early detection of injuries and diseases.

Blood pressure can be calculated from an electrocardiogram and a difference in timing of two pulsations of a pulse wave (a period of pulse wave propagation time), for example. A high blood pressure results in a short pulse wave propagation time, whereas a low blood pressure results in a long pulse wave propagation time. The body conditions of the user can be estimated from a relationship between the heart rate and the blood pressure that are calculated from the electrocardiogram and the pulse wave. For example, when both the heart rate and the blood pressure are high, it can be estimated that the user is nervous or excited, whereas when both the heart rate and the blood pressure are low, it can be estimated that the user is relaxed. When the state where the blood pressure is low and the heart rate is high is continued, the user might suffer from a heart disease or the like.

The user can check the biological data measured with the electronic device, one's own body conditions estimated on the basis of the data, and the like at any time; thus, health awareness is improved. This may inspire the user to reconsider the daily habits, for example, to avoid over-eating and over-drinking, get enough exercise, manage one's physical conditions, and have a medical examination at a medical institution as necessary.

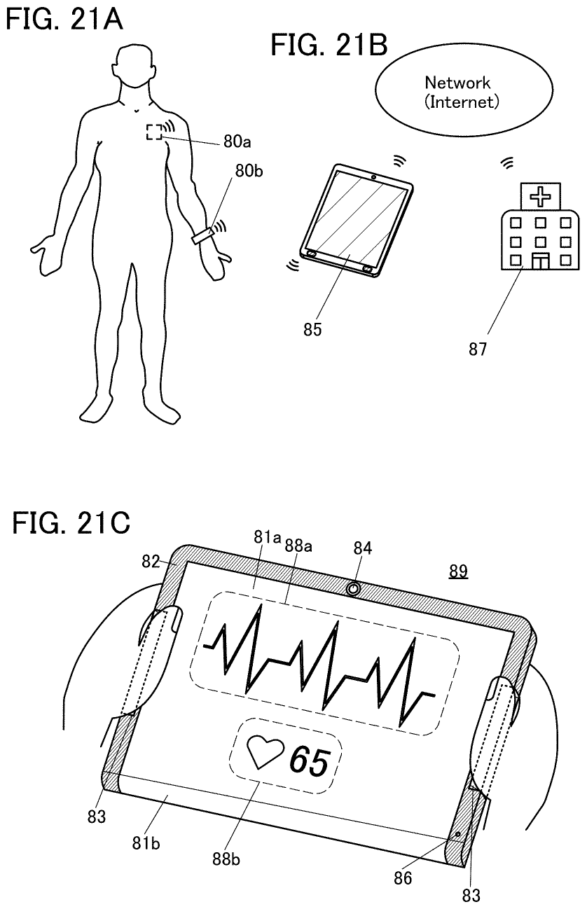

Data may be shared among a plurality of biosensors. FIG. 21A illustrates an example in which a biosensor 80a is embedded in a user's body and an example in which a biosensor 80b is worn on the user's wrist. Devices illustrated in FIG. 21A are, for example, a device including the biosensor 80a capable of electrocardiogram monitoring and a device including the biosensor 80b capable of heart rate monitoring by optical measurement of the pulse on the user's arm. Note that the wearable device such as a watch or a wristband illustrated in FIG. 21A is not limited to a heart rate meter, and a variety of types of biosensors can be used.

As the predetermined conditions of the embedded device illustrated in FIG. 21A, the device is small, hardly generates heat, and causes no allergic reaction or the like even when the device is in contact with the user's skin. The secondary battery used in the device of one embodiment of the present invention is preferable because it is small, hardly generates heat, and causes no allergic reaction or the like. The embedded device preferably incorporates an antenna so as to enable wireless charging.

The device embedded into the living body, which is illustrated in FIG. 21A, is not limited to the biosensor capable of electrocardiogram monitoring, and a biosensor capable of obtaining other biological data can be used.

The biosensor 80b incorporated in the device may have a function of storing obtained data in a temporary memory incorporated in the device. Alternatively, the data obtained by the biosensor may be transmitted to a portable data terminal 85 in FIG. 21B with or without a wire, and waveforms may be detected in the portable data terminal 85. The portable data terminal 85 is a smartphone or the like and can detect whether or not a problem such as an irregular heartbeat occurs from the data obtained from the biosensors. In the case where the data obtained by the plurality of biosensors is transmitted to the portable data terminal 85 with a wire, it is preferable that data obtained by connection with a wire be collectively transmitted. Note that date may be automatically given to the detected data, and the data may be stored in a memory of the portable data terminal 85 and managed personally. Alternatively, the data may be transmitted to a medical institution 87 such as a hospital via a network (including the Internet) as illustrated in FIG. 21B. The data can be managed in a data server of the hospital and used as inspection data in treatment. Since medical data sometimes swells to a huge amount of data, an network including Bluetooth (registered trademark) and a frequency band from 2.4 GHz to 2.4835 GHz may be used for the data communication between the biosensor 80b and the portable data terminal 85, and the fifth-generation (5G) wireless system may be used for the high-speed data communication from the portable data terminals 85. For the fifth-generation (5G) wireless system, frequency bands of the 3.7 GHz band, the 4.5 GHz band, and the 28 GHz band are used. With use of the fifth-generation (5G) wireless system, it becomes possible to obtain data and transmit the data to the medical institution 87, not only from home but also from the outside. As a result, data on poor physical conditions of the user can be accurately obtained and can be utilized for treatment performed later. Note that the portable data terminal 85 can have a structure illustrated in FIG. 21C.

FIG. 21C illustrates another example of a portable data terminal. A portable data terminal 89 includes a speaker, a pair of electrodes 83, a camera 84, and a microphone 86, in addition to a secondary battery.

The pair of electrodes 83 is provided in parts of a housing 82 with a display portion 81a therebetween. A display portion 81b is a curved region. The electrodes 83 function as electrodes for obtaining biological data.

Providing the pair of electrodes 83 in the longitudinal direction of the housing 82 as illustrated in FIG. 21C enables biological data to be obtained with the user being unconscious when the user uses the portable data terminal 89 with a landscape screen.

An example of the usage state of the portable data terminal 89 is illustrated. The display portion 81a can display electrocardiogram data 88a, heart-rate data 88b, and the like, which are obtained with the pair of electrodes 83.

This function is not necessary when the biosensor 80a is embedded in the user's body as illustrated in FIG. 21A. By contrast, when the biosensor 80a is not embedded, the user grasps the pair of electrodes 83 with the user's both hands, so that the electrocardiogram can be obtained. Even when the biosensor 80a is embedded in the user's body, the portable data terminal 89 illustrated in FIG. 21C can be used for checking whether the biosensor 80a operates normally. The portable data terminal 89 illustrated in FIG. 21C can also be used for comparing the electrocardiogram data with another user's.

The camera 84 can capture an image of the user's face, for example. Biological data on facial expression, a pupil, a complexion, and the like can be obtained from the image of the user's face.

The microphone 86 can obtain the user's voice. Voiceprint data that can be used for voiceprint authentication can be obtained from the obtained voice data. When voice data is regularly obtained and a change in voice quality is monitored, the voice data can be utilized for health management. Needless to say, talking on a video call with a doctor at the medical institution 87 is possible with use of the microphone 86, the camera 84, and the speaker.

With use of the device illustrated in FIG. 21A and the portable data terminal 89 illustrated in FIG. 21C, a remote medical support system can be achieved, in which data is transmitted from a remote area to a hospital to see a doctor.

This embodiment can be implemented in appropriate combination with the other embodiments.

### Example 1

In this example, a secondary battery of one embodiment of the present invention, which includes a base film and a cap layer, and a secondary battery as a comparative example, which does not include a base film or a cap layer, were fabricated and the charge and discharge characteristics and cycle performance thereof were evaluated.

### <Fabrication of Secondary Battery>

Sample 1 of one embodiment of the present invention was fabricated in the following manner. First, a titanium sheet was used to serve as both a substrate and a positive electrode current collector layer. As the titanium sheet, a non mirror rolled foil with a thickness of 0.1 mm and a purity of 99.5% was used after being processed by etching to be a diameter of 12 mm.

As a base film, titanium nitride (TiN) was deposited to 20 nm by a sputtering method over the titanium sheet. The sputtering conditions were as follows.

Target: titanium target, diameter of 100 mm
Sputtering power supply and output: DC power supply, 500 W
Atmosphere: argon flow rate of 12.0 sccm, nitrogen flow rate of 28 sccm, and pressure of 0.4 Pa
Deposition time: 8 minutes
Deposition temperature: set to 600° C.
Deposition rate: 2.5 nm/min

Next, as a positive electrode active material layer, lithium cobalt oxide (LiCoO₂) was deposited to 1000 nm by a sputtering method. The sputtering conditions were as follows.

Target: lithium cobalt oxide target, diameter of 100 mm
Sputtering power supply and output: RF power supply, 500 W
Atmosphere: argon flow rate of 40 sccm, oxygen flow rate of 10 sccm, and pressure of 0.4 Pa
Deposition time: 461 minutes
Deposition temperature: set to 600° C.
Deposition rate: 2.2 nm/min

Next, as a cap layer, titanium oxide (TiOₓ) was deposited to approximately 20 nm by a sputtering method. The sputtering conditions were as follows.

Target: titanium target, diameter of 100 mm
Sputtering power supply and output: DC power supply, 500 W
Atmosphere: argon flow rate of 24 sccm, oxygen flow rate of 16 sccm, and pressure of 0.4 Pa
Deposition time: 27.7 minutes
Deposition temperature: set to 600° C. (an actual substrate temperature of approximately 400° C.)
Deposition rate: 0.72 nm/min

In addition, Sample 2, which does not include a base film, and Sample 3, in which titanium oxide (TiOₓ) is deposited as a base film, were fabricated. Sample 2 and Sample 3 were fabricated in a manner similar to that for Sample 1 except for the base film.

As other comparative examples, Sample 4 to Sample 6, each of which does not include a cap layer, were fabricated. Sample 4 to Sample 6 were fabricated in a manner similar to that for Samples 1 to 3 except that the cap layer was not deposited.

Table 2 shows fabrication conditions of the samples.

TABLE 2

| | | Positive electrode | |
|---|---|---|---|
| | Base film | active material layer | Cap layer |
| Sample 1 | TiN | LiCoO₂ | TiOₓ |
| Sample 2 | Not | LiCoO₂ | TiOₓ |
| Sample 3 | TiOₓ | LiCoO₂ | TiOₓ |
| Sample 4 | TiN | LiCoO₂ | Not |
| Sample 5 | Not | LiCoO₂ | Not |
| Sample 6 | TiOₓ | LiCoO₂ | Not |

### <Fabrication of Battery Cell>

Next, with use of the samples as positive electrodes, CR2032 type coin battery cells (a diameter of 20 mm, a height of 3.2 mm) were fabricated.

A lithium metal was used for a counter electrode.

As an electrolyte contained in an electrolytic solution, 1 mol/L of lithium hexafluorophosphate (LiPF₆) was used. As the electrolytic solution, a solution in which ethylene carbonate (EC) and diethyl carbonate (DEC) were mixed at EC:DEC=3:7 (volume ratio) was used. Note that for secondary batteries used for evaluating the charge and discharge efficiency, 2 wt % of vinylene carbonate (VC) was added to the electrolytic solution.

As a separator, 25-μm-thick polypropylene was used.

A positive electrode can and a negative electrode can that were formed using stainless steel (SUS) were used.

### <Measurement of Charge and Discharge Efficiency>

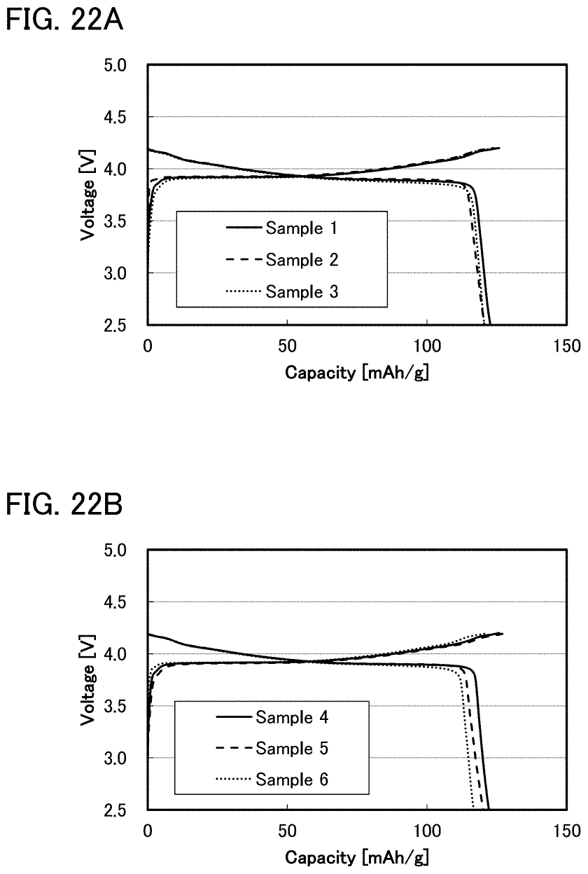

The initial characteristics were measured under conditions of CCCV charging, 0.2 C, 4.2 V, and a cutoff current of 0.1 C. Discharging was performed at 0.2 C with a cutoff voltage of 2.5 V. Note that here, 1 C was set to 137 mA/g, which was a current value per weight of the positive electrode active material. The measurement temperature was set to 25° C. The measurement results of the initial characteristics are shown in Table 3, FIG. 22A, and FIG. 22B. FIG. 22A is a graph of Sample 1 to Sample 3 and FIG. 22B is a graph of Sample 4 to Sample 6.

TABLE 3

| | | | Discharge |
|---|---|---|---|
| | Base film | Cap layer | capacity (mAh/g) |
| Sample 1 | TiN | TiOₓ | 123 mAh/g |
| Sample 2 | Not | TiOₓ | 121 mAh/g |
| Sample 3 | TiOₓ | TiOₓ | 121 mAh/g |
| Sample 4 | TiN | Not | 122 mAh/g |
| Sample 5 | Not | Not | 120 mAh/g |
| Sample 6 | TiOₓ | Not | 117 mAh/g |

According to Table 3, FIG. 22A, and FIG. 22B, all the samples exhibited favorable charge and discharge characteristics.

### <Charge and Discharge Cycle Performance>

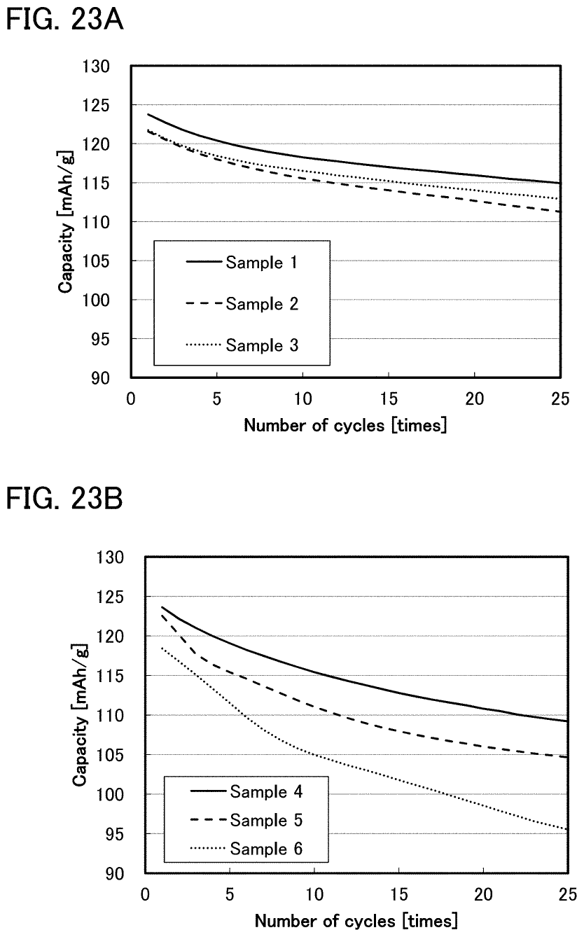

Next, the charge and discharge cycle performance of these battery cells was evaluated. Charge and discharge in the measurement of the cycle performance were performed in a manner similar to that for the measurement of the initial characteristics. The cycle performance results are shown in FIG. 23A and FIG. 23B. FIG. 23A is a graph of Sample 1 to Sample 3 and FIG. 23B is a graph of Sample 4 to Sample 6.

According to FIG. 23A and FIG. 23B, Sample 1 to Sample 3 including the cap layer exhibited much better cycle performance than Sample 4 to Sample 6 not including the cap layer. Sample 1, which contains titanium nitride as the base film, exhibited the best performance: the discharge capacity was 115 mAh/g and the discharge capacity retention rate was 93% after 25 cycles. Sample 3, which contains titanium oxide as the base film, exhibited the next best performance: the discharge capacity was 113 mAh/g and the discharge capacity retention rate was 93% after 25 cycles. Sample 2, which does not include the base film, exhibited a discharge capacity of 111 mAh/g and a discharge capacity retention rate of 92% after 25 cycles.

This indicates that the provision of the cap layer results in fabrication of a secondary battery with favorable charge and discharge cycle performance. It is also found that better charge and discharge cycle performance is achieved in the case where the base film, particularly titanium nitride, is included than in the case where the base film is not provided.

### Example 2

In this example, a secondary battery of one embodiment of the present invention, which includes a cap layer, and a secondary battery as a comparative example, which does not include a cap layer, were fabricated, and the characteristics thereof were analyzed by TEM, electron energy loss spectroscopy (EELS), nanobeam electron diffraction, impedance measurement, and the like to evaluate the cycle performance thereof

### <Fabrication of Secondary Battery>

Sample 11 of one embodiment of the present invention was fabricated in the following manner. First, a titanium sheet with a thickness of 100 μm was used to serve as both a substrate and a positive electrode current collector layer.

As a base film, titanium nitride (TiN) was deposited to 20 nm by a sputtering method over the titanium sheet. The sputtering conditions were as follows.

Target: titanium target, diameter of 2 inches
Sputtering power supply and output: RF power supply, 100 W
Atmosphere: argon flow rate of 3.0 sccm, nitrogen flow rate of 7 sccm, and pressure of 0.5 Pa
Deposition time: 15 minutes
Deposition temperature: set to 600° C.
Target-substrate distance: 75 mm

Next, as a positive electrode active material layer, lithium cobalt oxide (LiCoO₂) was deposited to 900 nm by a sputtering method. The sputtering conditions were as follows.

Target: lithium cobalt oxide target, diameter of 2 inches
Sputtering power supply and output: RF power supply, 200 W
Atmosphere: argon flow rate of 10 sccm and pressure of 0.5 Pa
Deposition time: 109 minutes
Deposition temperature: set to 600° C.
Target-substrate distance: 75 mm
Deposition rate: 9.2 nm/min

Next, as a cap layer, titanium oxide (TiO₂) was deposited to 20 nm by a sputtering method. The sputtering conditions were as follows.

Target: titanium target, diameter of 100 mm
Sputtering power supply and output: DC power supply, 500 W
Atmosphere: argon flow rate of 24 sccm, oxygen flow rate of 16 sccm, and pressure of 0.4 Pa
Deposition time: 27.7 minutes
Deposition temperature: set to 600° C. (an actual substrate temperature of approximately 400° C.)
Deposition rate: 0.72 nm/min

As a comparative example, Sample 12, which does not include a cap layer, was fabricated. Sample 12 was fabricated in a manner similar to that for Sample 11 except for the cap layer.

Table 4 shows fabrication conditions of the samples.

TABLE 4

| | Base film | Cap layer |
|---|---|---|
| Sample 11 | TiN | TiOx |
| Sample 12 | TiN | Not |

### <TEM>

TEM images were taken under the following conditions.

Pretreatment of sample: Slicing by an FIB method (μ-sampling method)
Transmission electron microscope: JEM-ARM200F manufactured by JEOL Ltd.
Observation condition, acceleration voltage: 200 kV
Magnification accuracy: ±3%

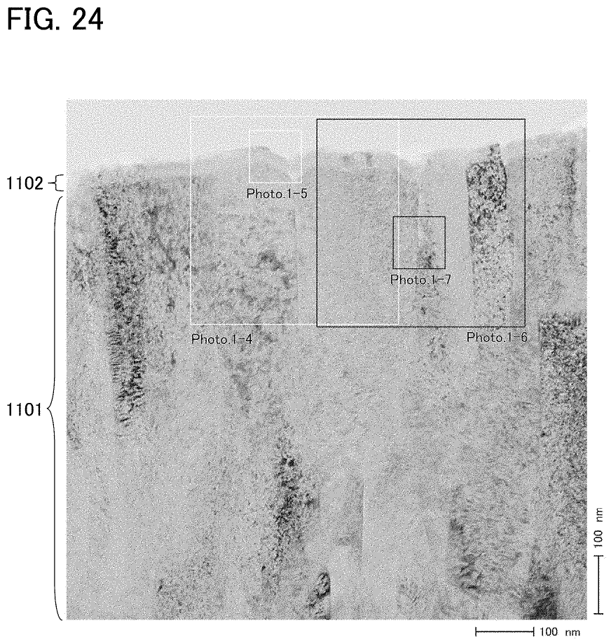

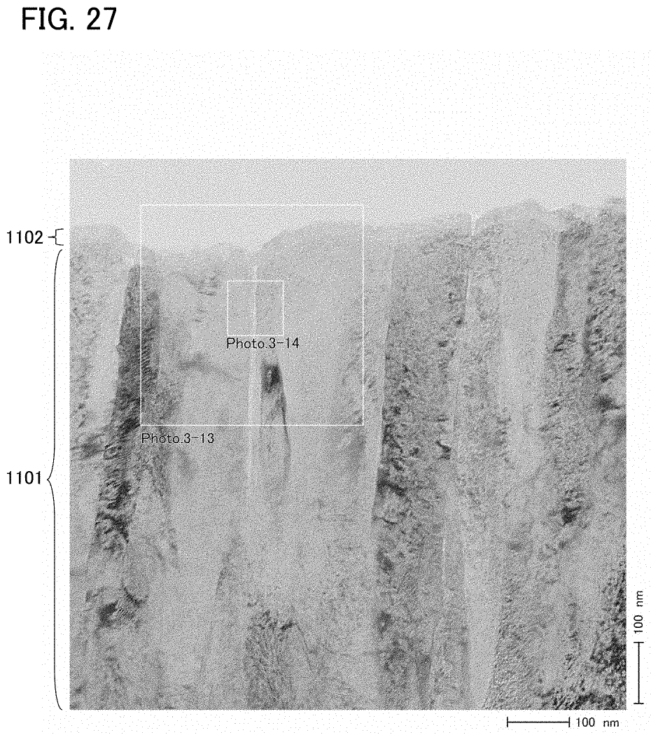

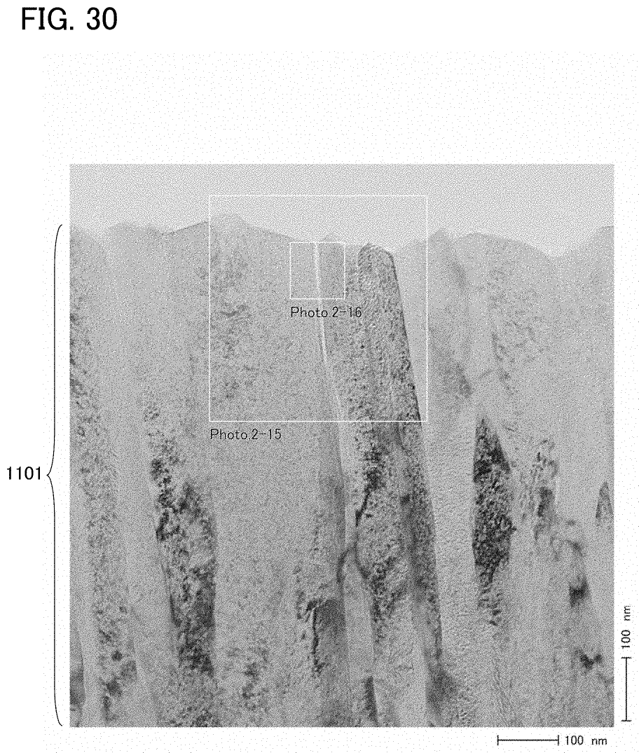

FIG. 24 shows a cross-sectional TEM image of Sample 11 before charge and discharge. A cap layer 1102 of titanium oxide was observed in a superficial portion. FIG. 27 shows a cross-sectional TEM image of Sample 11 after charge and discharge. The cap layer 1102 of titanium oxide was observed in a superficial portion. FIG. 30 shows a cross-sectional TEM image of Sample 12 after charge and discharge. In the observation of each sample, a positive electrode active material layer 1101 of lithium cobalt oxide was polycrystalline and a crystallite had a columnar shape long in the vertical direction.

### <EELS>

Then, the electron state of cobalt in the samples after charge and discharge was analyzed using EELS, and the valence was calculated from L₃/L₂ with reference to Non-Patent Document 1. The measurement conditions of EELS were as follows.

Element analysis (point analysis)
Scanning transmission electron microscope: JEM-ARM200F manufactured by JEOL Ltd.
Acceleration voltage: 200 kV
Beam diameter: approximately 0.1 nmϕ
Element analysis apparatus: Quantum ER manufactured by Gatan Inc.
Photoelectron spectrometer: MOS detector array
Taking time: 30 seconds

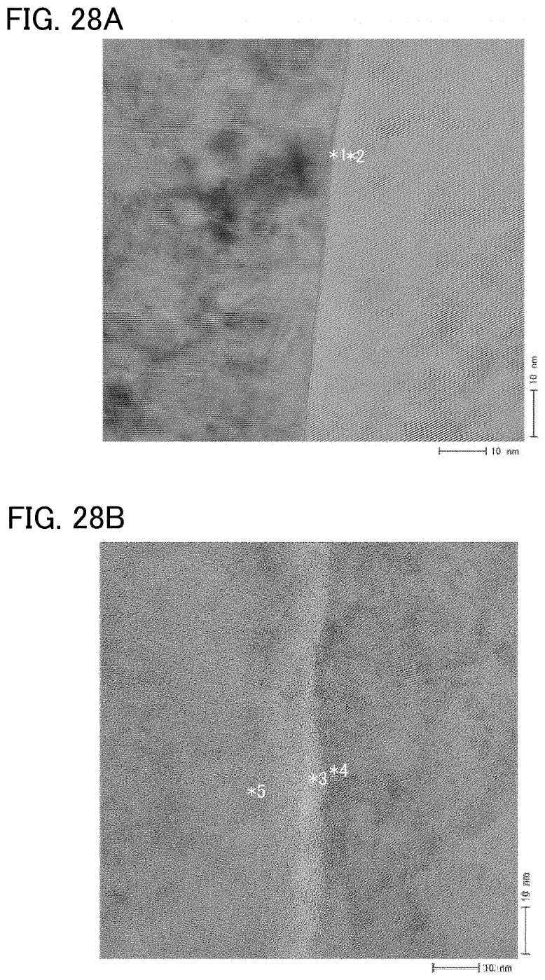

EELS analysis points of Sample 11 after charge and discharge are represented by *1 and *2 in FIG. 28A, and *3, *4, and *5 in FIG. 28B. Note that *1 and *2 each denote a depth of approximately 100 nm from the outermost surface of a lithium cobalt oxide layer toward the substrate; and *3 to *5 each denote a depth of approximately 30 nm. Each analysis point is a grain boundary or the vicinity thereof; *2, *4, and *5 are inner parts of the crystal grain compared with *1 and *3. Note that FIG. 28B is an enlarged image of a photo. 3-14 enclosed by a white line in FIG. 27.

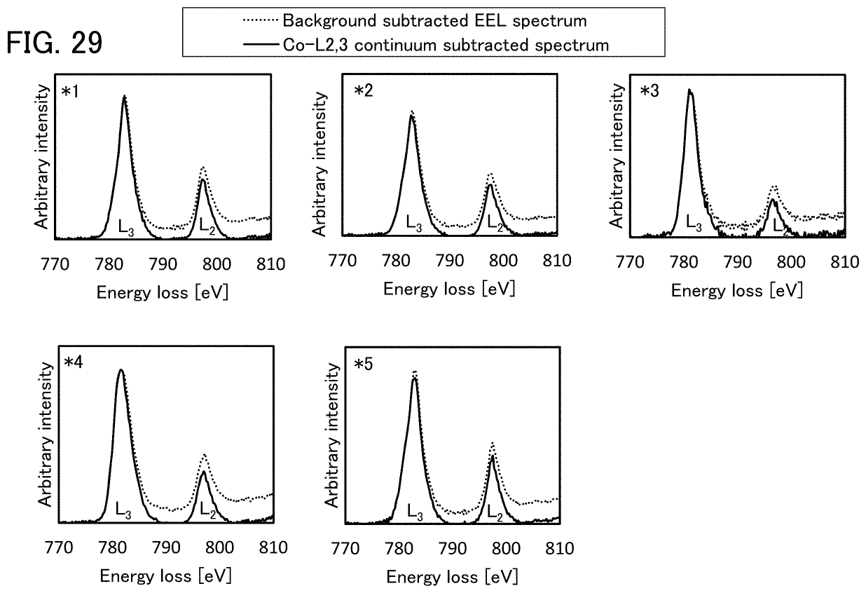

FIG. 29 shows the EELS spectra of Sample 11 at the points represented by *1 to *5. FIG. 29 shows an EEL spectrum (Background subtracted EEL spectrum), which is obtained by subtracting the background calculated on the bond energy side lower than Co-L₃ edge, and L₃ state-L₂ state continuous spectrum of cobalt (Co-L_{2,3} continuum subtracted spectrum), which is obtained by further subtracting the background calculated on the energy band between Co-L₃ edge and Co-L₂ edge. Note that the Background subtracted EEL spectrum was obtained by subtracting the background from the original data fitted with a power law model. The Co-L_{2,3} continuum subtracted spectrum was obtained by further subtracting a model of scattering cross-sectional area of cobalt (Hartree-slater cross section model) as a background function from the above data from which the background had been removed with power law fitting. Table 5 shows the area intensity ratio of L₃/L₂ and the calculated valences of cobalt.

TABLE 5

| Measurement point | | L₃/L₂ | Co valence |
|---|---|---|---|
| Sample 11 | *1 | 2.8 | 3.0 |
| | *2 | 2.9 | 2.9 |
| | *3 | 4.2 | 2.2 |
| | *4 | 3.8 | 2.4 |
| | *5 | 2.8 | 3.0 |

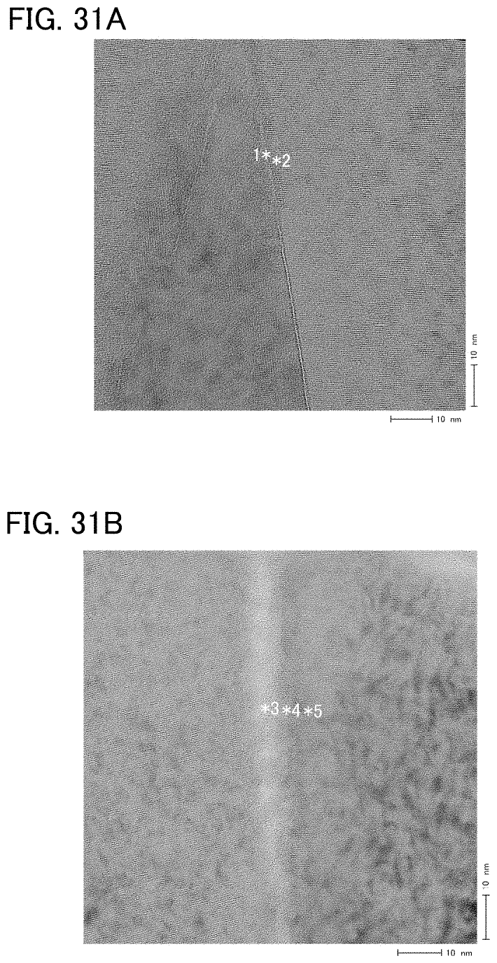

FIG. 31A and FIG. 31B are cross-sectional TEM images of Sample 12 after charge and discharge. EELS analysis points are represented by *1 and *2 in FIG. 31A, and *3, *4, and *5 in FIG. 18B. Each analysis point is a grain boundary or the vicinity thereof; *2, *4, and *5 are inner parts of the crystal grain compared with *1 and *3. Note that FIG. 31B is an enlarged image of a photo. 2-16 surrounded by a white line in FIG. 30.

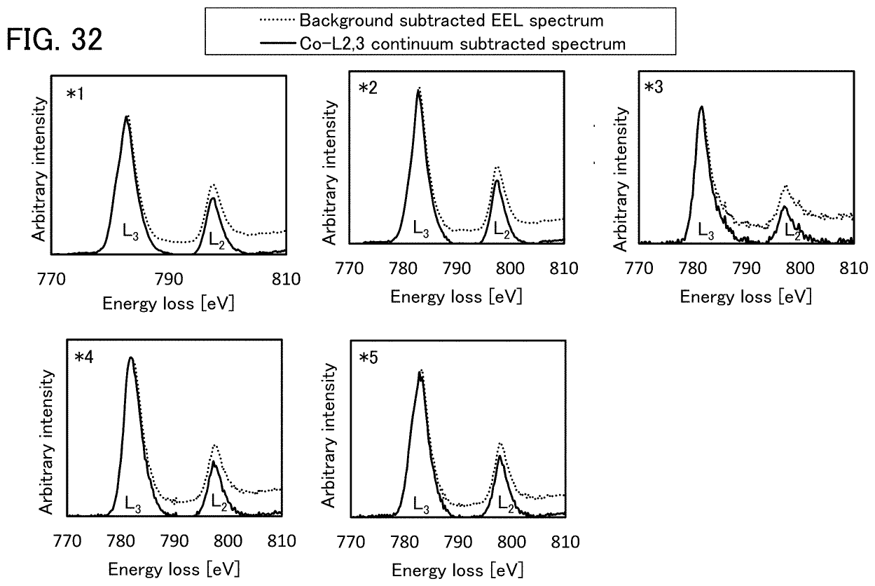

FIG. 32 shows the EELS spectra of Sample 12 after charge and discharge at the five points of *1 to *5. Table 6 shows the area intensity ratio of L₃/L₂ and the calculated valences of cobalt.

TABLE 6

| Measurement point | | L₃/L₂ | Co valence |
|---|---|---|---|
| Sample 12 | *1 | 3.0 | 2.8 |
| | *2 | 2.9 | 2.9 |
| | *3 | 3.6 | 2.2 |
| | *4 | 3.6 | 2.2 |
| | *5 | 3.0 | 2.8 |

Table 5 and Table 6 clearly show that reduction of cobalt in the crystal grain is suppressed more in Sample 11 including the cap layer. This suggests that degradation of a layered rock-salt crystal structure can be suppressed by providing the cap layer.

### <Nanobeam Electron Diffraction>

Next, the crystal structures of the grain boundary of lithium cobalt oxide and the vicinity thereof were analyzed by nanobeam electron diffraction.

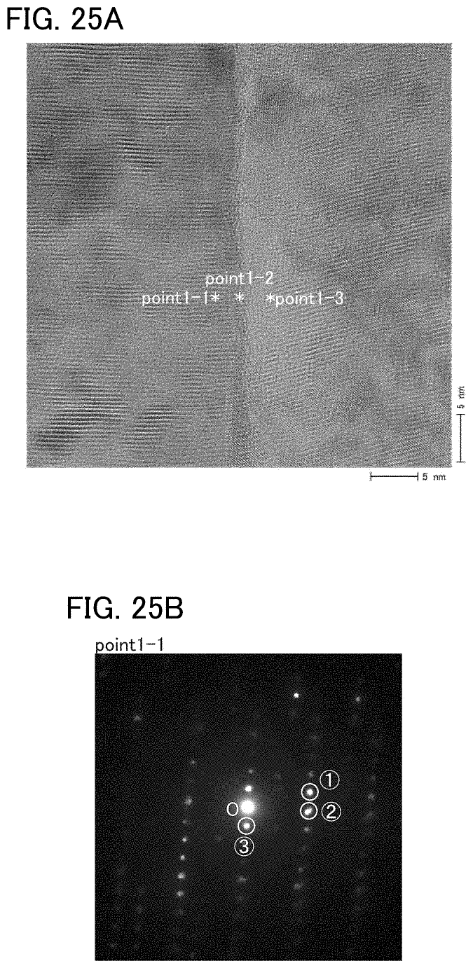

FIG. 25A is a cross-sectional TEM image of Sample 11 before charge and discharge. Analysis points by nanobeam electron diffraction are represented by *point 1-1, *point 1-2, and *point 1-3 in FIG. 25A. Note that FIG. 25A is an enlarged image of a photo. 1-7 surrounded by a black line in FIG. 24.

FIG. 25B shows a nanobeam electron diffraction pattern of *point 1-1. In the figure, transmission light is represented by 0, and some of diffraction spots are represented by 1, 2, and 3. As the result of the *point 1-1 analysis, the interplanar spacings of 1, 2, and 3 were calculated to be 0.137 nm, 0.143 nm, and 0.464 nm, respectively. The interplanar angles were ∠1O2=17°, ∠1O3=107°, and ∠2O3=90°. In that case, the incident direction of the electron beam is [120] and the interplanar spacings and the interplanar angles suggest that 1 is −213 of a layered rock-salt crystal, 2 is −210 of a layered rock-salt crystal, and 3 is 00-3 of a layered rock-salt crystal, which indicates that the layered rock-salt crystal structure is included. From these d values, the lattice constants of *point 1-1 were calculated to be a=2.86 (Å) and c=13.9 (Å).

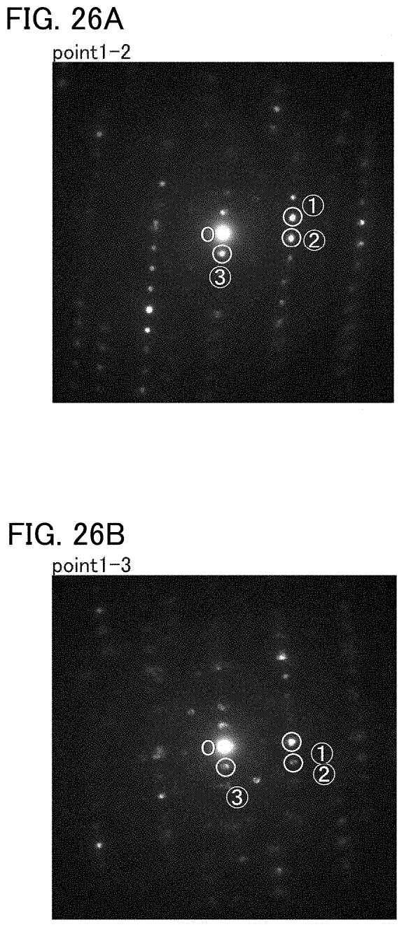

FIG. 26A shows a nanobeam electron diffraction pattern of *point 1-2. In the figure, transmission light is represented by O, and some of diffraction spots are represented by 1, 2, and 3. As the result of the *point 1-2 analysis, the interplanar spacings of 1, 2, and 3 were calculated to be 0.137 nm, 0.143 nm, and 0.464 nm, respectively. The interplanar angles were ∠1O2=17°, ∠1O3=107°, and ∠2O3=90°. In that case, the incident direction of the electron beam is [120] and the interplanar spacings and the interplanar angles suggest that 1 is −213 of a layered rock-salt crystal, 2 is −210 of a layered rock-salt crystal, and 3 is 00-3 of a layered rock-salt crystal, which indicates that the layered rock-salt crystal structure is included. From these d values, the lattice constants of *point 1-2 were calculated to be a=2.86 (Å) and c=13.9 (Å).

FIG. 26B shows a nanobeam electron diffraction pattern of *point 1-3. In the figure, transmission light is represented by O, and some of diffraction spots are represented by 1, 2, and 3. As the result of the *point 1-3 analysis, the interplanar spacings of 1, 2, and 3 were calculated to be 0.146 nm, 0.139 nm, and 0.463 nm, respectively. The interplanar angles were ∠1O2=17°, ∠1O3=90°, and ∠2O3=72°. In that case, the incident direction of the electron beam is [120] and the interplanar spacings and the interplanar angles suggest that 1 is −210 of a layered rock-salt crystal, 2 is −21-3 of a layered rock-salt crystal, and 3 is 00-3 of a layered rock-salt crystal, which indicates that the layered rock-salt crystal structure is included. From these d values, the lattice constants of *point 1-3 were calculated to be a=2.92 (Å) and c=13.9 (Å).

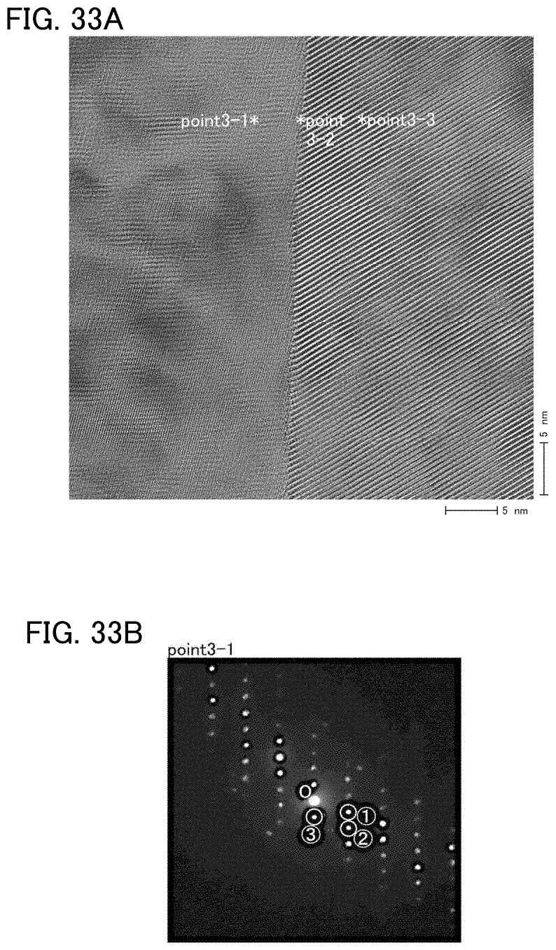

FIG. 33A is a cross-sectional TEM image of Sample 11 after charge and discharge. Analysis points by nanobeam electron diffraction are represented by *point 3-1, *point 3-2, and *point 3-3 in FIG. 33A.

FIG. 33B shows a nanobeam electron diffraction pattern of *point 3-1. In the figure, transmission light is represented by O, and some of diffraction spots are represented by 1, 2, and 3. As the result of the *point 3-1 analysis, the interplanar spacings of 1, 2, and 3 were calculated to be 0.227 nm, 0.183 nm, and 0.475 nm, respectively. The interplanar angles were ∠1O2=21°, ∠1O3=71°, and ∠2O3=50°. In that case, the incident direction of the electron beam is [0-10] and the interplanar spacings and the interplanar angles suggest that 1 is 10-2 of a layered rock-salt crystal, 2 is 10-5 of a layered rock-salt crystal, and 3 is 00-3 of a layered rock-salt crystal, which indicates that the layered rock-salt crystal structure is included. From these d values, the lattice constants of *point 3-1 were calculated to be a=2.76 (Å) and c=14.2 (Å).

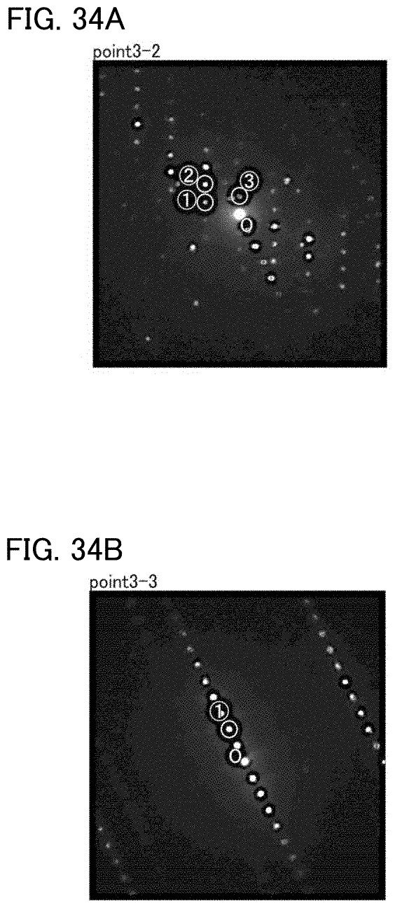

FIG. 34A shows a nanobeam electron diffraction pattern of *point 3-2. In the figure, transmission light is represented by O, and some of diffraction spots are represented by 1, 2, and 3. As the result of the *point 3-2 analysis, the interplanar spacings of 1, 2, and 3 were calculated to be 0.226 nm, 0.181 nm, and 0.468 nm, respectively. The interplanar angles were ∠1O2=22°, ∠1O3=71°, and ∠2O3=49°. In that case, the incident direction of the electron beam is [0-10], 1 is −102 of a layered rock-salt crystal, 2 is −105 of a layered rock-salt crystal, and 3 is 003 of a layered rock-salt crystal, which indicates that the layered rock-salt crystal structure is included. From these d values, the lattice constants of *point 3-2 were calculated to be a=2.74 (Å) and c=14.1 (Å).

FIG. 34B shows a nanobeam electron diffraction pattern of *point 3-3. In the figure, transmission light is represented by O, and some of diffraction spots are represented by 1. As the result of the *point 3-3 analysis, the interplanar spacing of 1 was calculated to be 0.470 nm. In that case, the incident direction of the electron beam is [003] and 1 is 003 of a layered rock-salt crystal, which indicates that the layered rock-salt crystal structure is included. From the d value, the lattice constant of *point 3-3 was calculated to be c=14.0 (Å). The a-axis was not calculated because the corresponding d value did not exist.

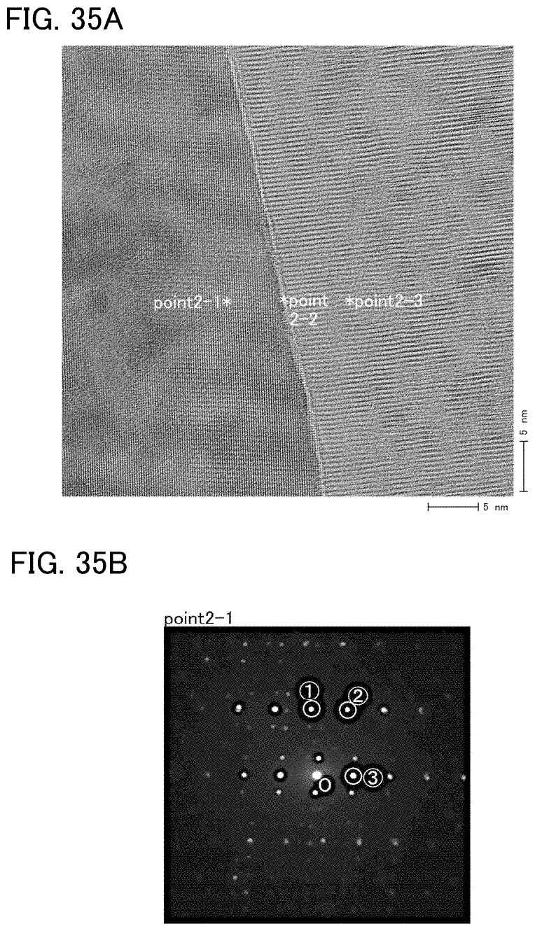

FIG. 35A is a cross-sectional TEM image of Sample 12 after charge and discharge. Analysis points by nanobeam electron diffraction are represented by *point 2-1, *point 2-2, and *point 2-3 in FIG. 35A.

FIG. 35B shows a nanobeam electron diffraction pattern of *point 2-1. In the figure, transmission light is represented by O, and some of diffraction spots are represented by 1, 2, and 3. As the result of the *point 2-1 analysis, the interplanar spacings of 1, 2, and 3 were calculated to be 0.125 nm, 0.115 nm, and 0.234 nm, respectively. The interplanar angles were ∠1O2=29°, ∠1O3=96°, and ∠2O3=66°. In that case, the incident direction of the electron beam is [010], 1 is 20-1 of a layered rock-salt crystal, 2 is 205 of a layered rock-salt crystal, and 3 is 006 of a layered rock-salt crystal, which indicates that the layered rock-salt crystal structure is included. From these d values, the lattice constants of *point 2-1 were calculated to be a=2.91 (Å) and c=14.1 (Å).

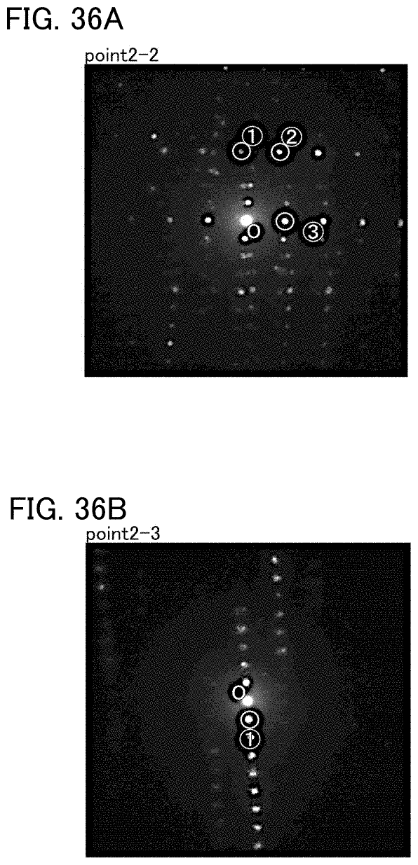

FIG. 36A shows a nanobeam electron diffraction pattern of *point 2-2. In the figure, transmission light is represented by O, and some of diffraction spots are represented by 1, 2, and 3. As the result of the *point 2-2 analysis, the interplanar spacings of 1, 2, and 3 were calculated to be 0.126 nm, 0.115 nm, and 0.234 nm, respectively. The interplanar angles were ∠1O2=29°, ∠1O3=95°, and ∠2O3=66°. In that case, the incident direction of the electron beam is [010], 1 is 20-1 of a layered rock-salt crystal, 2 is 205 of a layered rock-salt crystal, and 3 is 006 of a layered rock-salt crystal, which indicates that the layered rock-salt crystal structure is included. From these d values, the lattice constants of *point 2-2 were calculated to be a=2.91 (Å) and c=14.1 (Å).

FIG. 36B shows a nanobeam electron diffraction pattern of *point 2-3. In the figure, transmission light is represented by O, and some of diffraction spots are represented by 1. As the result of the *point 2-3 analysis, the interplanar spacing of 1 was calculated to be 0.474 nm. In that case, the incident direction of the electron beam is [003] and 1 is 003 of a layered rock-salt crystal, which indicates that the layered rock-salt crystal structure is included. From the d value, the lattice constant of *point 2-3 was calculated to be c=14.21 (Å). The a-axis was not calculated because the corresponding d value did not exist.

As described above, the lattice constant of Sample 11 not including the cap layer after charge and discharge tends to be larger than the lattice constant of lithium cobalt oxide before charge and discharge. This is probably due to reduction of cobalt.

In contrast, in Sample 12 including the cap layer, the a-axis tends to be small on average even after charge and discharge. This indicates that cobalt has a large valence and reduction of cobalt is suppressed.

### <Charge and Discharge Cycle>

Next, secondary batteries were fabricated using Sample 11 and Sample 12, and their charge and discharge cycle performance was evaluated.

With use of Sample 11 and Sample 12 as positive electrodes and a lithium metal as a counter electrode, CR2032 type coin battery cells (a diameter of 20 mm and a height of 3.2 mm) were fabricated.

As an electrolyte included in an electrolytic solution, 1 mol/L lithium hexafluorophosphate (LiPF₆) was used. As the electrolytic solution, a solution in which ethylene carbonate (EC) and diethyl carbonate (DEC) were mixed at a volume ratio of EC:DEC=3:7 and vinylene carbonate (VC) was added as an additive at 2 wt % was used.

As a separator, 25-μm-thick polypropylene was used.

A positive electrode can and a negative electrode can that were formed using stainless steel (SUS) were used.

A cycle test was performed under the following conditions. The charge voltage was set to 4.2 V. The measurement temperature was set to 25° C. CC/CV charging (0.2 C, 0.1 Ccut) and CC discharging (0.1 C, 2.5 Vcut) were performed, and a 10-minute break was taken before the next charging. Note that 1 C was set to 137 mA/g in this example and the like.

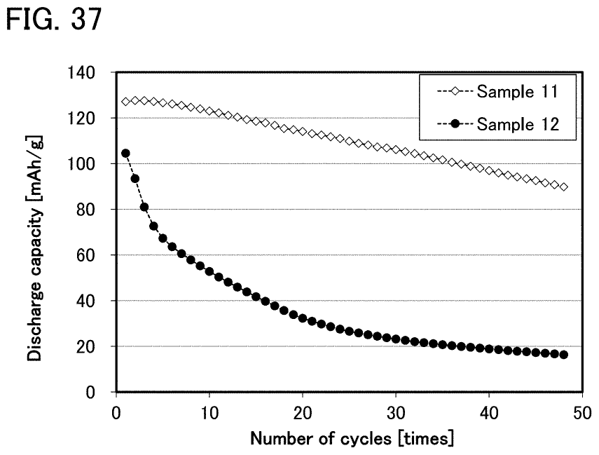

FIG. 37 shows the results of charge and discharge cycle tests. The positive electrode of Sample 11 including the cap layer exhibited extremely favorable charge and discharge cycle performance as compared with that of Sample 12 not including the cap layer.

### <Impedance>

The impedance of each secondary battery was measured in the above charge and discharge cycle test.

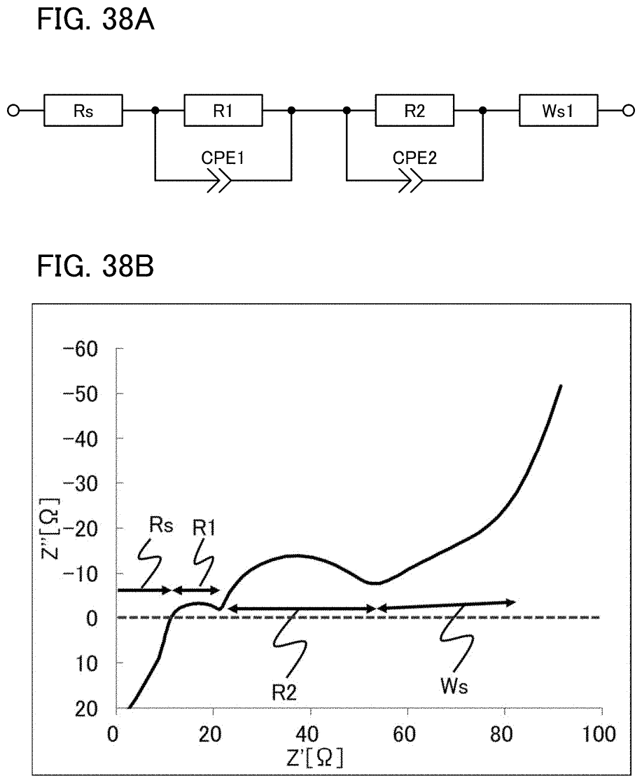

In this example, an electrochemical phenomenon generated in the secondary battery of one embodiment of the present invention is analyzed with an equivalent circuit shown in FIG. 38A.

Here, Rs is the electric resistance of an electrode and the resistance of an electrolytic solution. The electric resistance of the electrode includes all simple electric resistances included in the coin cell. The resistance of the electrolytic solution refers to the diffusive resistance of ions in the solution.

R1 is denoted by Rf or Rsurface in some cases, which means a high-frequency component of the impedance of the secondary battery. R1 includes the diffusive resistance of lithium ions at the interface between the positive electrode and the electrolytic solution.

CPE1 (constant phase element, electric double layer capacitance) is the capacitance that reproduces the behavior on a porous electrode.

R2 is denoted by Rct in some cases, which means a low-frequency component. R2 includes the resistance in the process (charge transfer) in which Li ions are inserted into and extracted from a positive electrode active material layer (LiCoO₂ in this example).

Ws1 is the resistance with lithium diffusion in a solid.

The graph of FIG. 38B shows a typical impedance. The range affected by each component is shown in the graph.

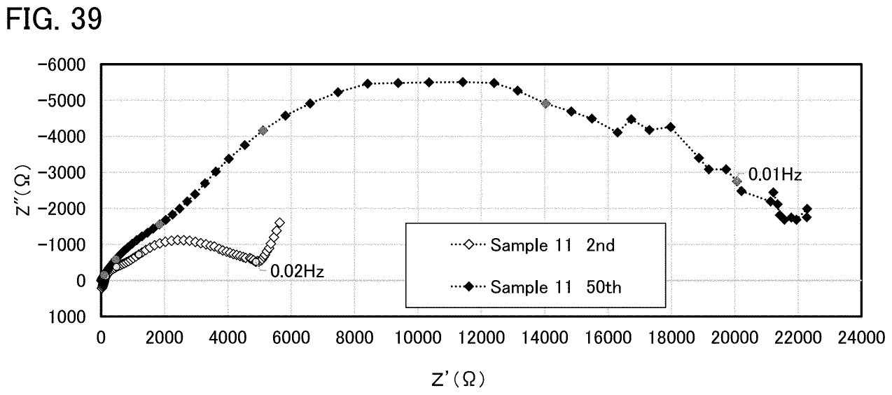

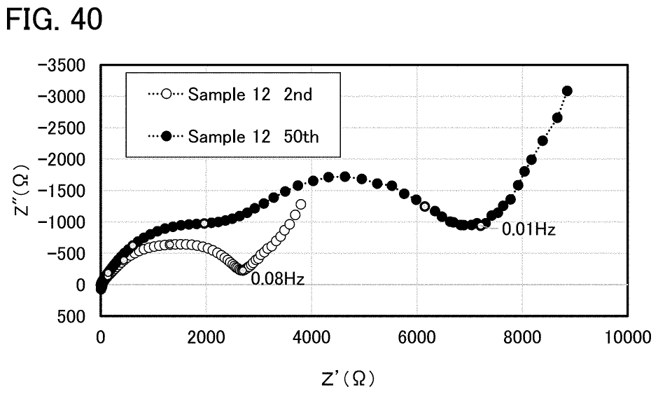

The impedance of Sample 11 is shown in FIG. 39, and the impedance of Sample 12 is shown in FIG. 40. Each of the graphs shows the second cycle and the 50th cycle. As the measurement device, CELLTEST multichannel electrochemical measurement system manufactured by Solartron Analytical Inc. was used and an AC voltage of 10 mV was swept from 0.001 Hz to 1 MHz. The measurement temperature was set to 25° C. Before the measurement of the impedance, the samples were charged at 0.2 C to a voltage of 4.2 V and left for 2 hours. OCV of Sample 11 at this time was 4.1308 V after 2 cycles and 4.0607 V after 50 cycles. OCV of Sample 12 was 4.1162 V after 2 cycles and 4.0005 V after 50 cycles.

The comparison of the impedance of Sample 12 between the second cycle and the 50th cycle shows a significant increase in R1 (high-frequency component) as shown in FIG. 40. This suggests that degradation occurs in the diffusion path of lithium, e.g., the interface between the positive electrode active material layer and the electrolytic solution and part of a crystal grain boundary, causing lowering of the charge and discharge cycle performance as shown in FIG. 37.

In contrast, the comparison of the impedance of Sample 11 between the second cycle and the 50th cycle shows a relatively small increase in R1 as shown in FIG. 39. This suggests that generation of a coating film can be suppressed by the effect of the cap layer. In addition, R2 (low-frequency component) greatly increases. This suggests that degradation occurs in the LiCoO₂ crystal structure.

### REFERENCE NUMERALS

100: positive electrode, 101: positive electrode active material layer, 102: cap layer, 103: positive electrode current collector, 104: base film, 110: substrate, 111: substrate, 200: secondary battery, 201: secondary battery, 202: secondary battery, 203: solid electrolyte layer, 204: negative electrode active material layer, 205: negative electrode current collector, 206: protective layer, 209: cap layer, 210: negative electrode, 211: negative electrode, 212: negative electrode, 213: solid electrolyte layer, 214: base film, 215: positive electrode current collector, 220: separator, 221: electrolytic solution, 222: exterior body, 223a: lead electrode, 223b: lead electrode, 230: secondary battery, 231: secondary battery

1. A positive electrode for a secondary battery, comprising a base film, a positive electrode active material layer, and a cap layer,
wherein at least one of the base film and the cap layer comprises titanium oxynitride, and
wherein the positive electrode active material layer comprises lithium cobalt oxide.

2. The positive electrode for a secondary battery, according to claim 1,
wherein a crystal structure included in the base film and a crystal structure included in the positive electrode active material layer each have a plane where only anions are arranged.

3. The positive electrode for a secondary battery, according to claim 1,
wherein the base film and the positive electrode active material layer each have a crystal structure where cations and anions are alternately arranged.

4. A secondary battery comprising:
the positive electrode for a secondary battery according to claim 1;
a solid electrolyte; and
a negative electrode.

5. An electronic device comprising the secondary battery according to claim 4.

6. A system comprising:
the secondary battery according to claim 4; and
a lithium-ion secondary battery comprising a positive electrode, a negative electrode, an electrolytic solution, and a separator.

7. A positive electrode for a secondary battery, comprising a positive electrode current collector, a base film, a positive electrode active material layer, and a cap layer,
wherein the base film is over the positive electrode current collector,
wherein the positive electrode active material layer is over the base film,
wherein the cap layer is over the positive electrode active material layer,
wherein the base film comprises titanium and oxygen,
wherein the cap layer comprises titanium and oxygen,
wherein the positive electrode active material layer comprises lithium cobalt oxide.

8. The positive electrode for a secondary battery, according to claim 7,
wherein the base film comprises nitrogen, and
wherein the cap layer comprises nitrogen.

9. The positive electrode for a secondary battery, according to claim 7,
wherein the cap layer comprises TiOxNy,
wherein 0<x<2 and 0<y<1.
